(19) United States
(12) Patent Application Publication
(10) Pub. No.: US 2024/0310108 A1
(43) Pub. Date: Sep. 19, 2024

(54) REFRIGERATOR

(71) Applicant: LG ELECTRONICS INC., Seoul (KR)

(72) Inventors: Hee Jun LEE, Seoul (KR); JinHo CHANG, Seoul (KR); Jae Un SHIN, Seoul (KR)

(21) Appl. No.: 18/575,129

(22) PCT Filed: Jun. 24, 2022
(86) PCT No.: PCT/KR2022/009006

§ 371 Date: Dec. 28, 2023

(30) Foreign Application Priority Data
Aug. 19, 2021 (KR) 10-2021-0109704

(51) Int. Cl. F25D 23/02; E05F 15/614

(52) U.S. Cl. CPC F25D 23/028; E05F 15/614; E05Y 2201/426; E05Y 2201/722; E05Y 2900/31; F25D 2323/024

(57) ABSTRACT

A refrigerator is provided with a door opening device which assists in opening a door, and such a door opening device is configured to be used by being installed upside down according to the position of a hinge. Accordingly, the door may be automatically opened or an opening force of the door may be reduced during the opening of the door.

### TECHNICAL FIELD

The present disclosure relates to a refrigerator having a door opening device which automatically opens a door or assists in opening the door.

### BACKGROUND ART

A refrigerator is a home appliance that uses cold air to store items for a long time. Such a refrigerator provides at least one storage compartment in which items are stored, and the storage compartment is configured to be opened and closed by a door.

In general, a gasket is provided on a surface of a refrigerator door facing a cabinet to maintain airtightness therebetween such that leakage of cold air of the storage compartment can be prevented.

The gasket is formed of a compressible material or in a compressible shape and is closely attached between the door and the cabinet. Particularly, in a conventional technology, as the gasket is provided with a magnet, the gasket is adhered to the cabinet to maintain airtightness when the door is closed.

The adhesion of the gasket is inversely proportional to the amount of the leakage of cold air in the storage compartment. That is, as the adhesion of the gasket increases, the amount of cold air leakage decreases.

However, as the adhesion of the gasket increases, it is more difficult for a user to open the door. That is, as the adhesion of the gasket increases, force required to open the door increases.

Accordingly, in the conventional technology, in order to reduce difficulty in opening the door, the adhesion of a gasket is weak, and accordingly, there is a problem that there is a large amount of cold air leakage.

Recently, in order to automatically open a refrigerator door, or to assist opening a door, various types of door opening devices or structures have been provided. These door opening devices are variously provided as disclosed in Korean Patent Application Publication No. 10-2009-0091455 (Patent Document 1), Korean Patent Application Publication No. 10-2016-0029514 (Patent Document 2), Korean Patent Application Publication No. 10-2018-0049702 (Patent Document 3), Korean Patent Application Publication No. 10-2018-0119027 (Patent Document 4), Korean Patent Application Publication No. 10-2018-0119031 (Patent Document 5), and Korean Patent Application Publication No. 10-2019-0075671 (Patent Document 6), etc.

That is, in each of the prior arts of Patent Documents described above, when a door is opened or a signal for opening a door is provided, a pressing force greater than the adhesion force of the gasket is provided to allow a main body to be forcibly spaced apart from the door or to assist the main body to be spaced apart from the door.

Accordingly, cold air leakage is prevented by increasing the adhesion of the gasket, and a user can conveniently open the door.

However, each of the door opening devices according to the prior arts described above described above has various problems.

For example, in case of the prior art of Patent Document 1, an entire structure is large and complicated, and thus it is difficult to manufacture and assemble. Accordingly, a large installation space is required, which inevitably causes interference with various structures.

In addition, in Patent Document 1, a door is configured to be opened by an opening cam, and thus the opening distance of the door is inevitably short, and accordingly, the opening amount of the door is inevitably small.

Additionally, in Patent Document 1, during the operation of a door opening device, the opening cam generates impact noise by hitting the door, so a user' reliability for a product is low, and due to frequent hitting and scratches, the surface of the door may be damaged.

Furthermore, in case of the prior art of each of Patent Documents 2 to 5, a door opening device is configured to be provided on the upper surface of the door, it is difficult to apply the prior art to a refrigerator in which the front-to-rear width (thickness) of a door is relatively small. That is, the prior art of each of Patent Documents 2 to 5 is applied only to a specific type of refrigerator, but cannot be applied in common to various types of refrigerators.

In addition, in case of the prior art of each of Patent Documents 2 to 5, the door opening device is configured to be provided on the upper surface of the door, so a rack cannot be configured to have length longer than the front-to-rear width of the door. Accordingly, the door opening device of the prior art of each of Patent Documents 2 to 5 cannot be used in common in various doors.

Furthermore, in the prior art, in order to increase the length of the rack, the rack was installed to have an oblique or round shape. However, despite this design, it is difficult to open the door by a sufficient distance. Particularly, in case of a refrigerator in which only one door is provided, adhesion of the door is significantly higher than adhesion of each of a plurality of doors when the doors are provided, so it is more difficult to open the door, and the door malfunctions frequently.

Additionally, in case of the prior art of each of Patent Documents 2 to 5, the door opening device is configured to be provided on the upper surface of the door, so there is difficulty in connecting a power line located in the cabinet of a refrigerator.

In addition, in case of the prior art of Patent Document 3, during the operation of a rack body, in order to absorb impact or prevent scratches, a rack cover is installed rotatably on the end of the rack body. However, since the rack cover is made of rubber or silicone, the rack cover may be torn or damaged due to frequent rotation and may be removed from the rack body.

Furthermore, in a structure in which the door opening device of the prior art of Patent Document 4 is installed on the upper surface of a main body, a rack pressing the door is configured to have an oblique or round shape, and thus a portion of contact of the rack with the door changes according to the opening angle of the door, so the contact portion may be scratched.

Additionally, in the door opening device disclosed in Patent Documents 1 to 6, a rack is inevitably configured to have short length. Accordingly, there is design limitation in that the associated door opening device is required to be located in the vicinity of a hinge.

Meanwhile, the door opening device disclosed in Patent Documents 1 to 6 described above is not symmetrical left and right, different door opening devices are inevitably provided respectively on doors located at left and right sides, and cannot be used in common.

Particularly, according to each of the prior arts described above, the door opening device is configured to be exposed to the outside by protruding from the upper surface of the cabinet, so it is difficult to improve design satisfaction. Of course, in the prior art, a hinge cover is installed to cover the door opening device, but it is difficult to improve design as much as the protrusion height of the door opening device.

### DISCLOSURE

### Technical Problem

The present disclosure is intended to propose a refrigerator in which a compact door opening device whose structure is simplified may be provided.

The present disclosure is intended to propose a refrigerator in which the length of a rack bar constituting the door opening device is sufficiently long such that a door may be opened by at least a predetermined distance regardless of the type of a refrigerator or the door.

The present disclosure is intended to propose a refrigerator in which contact noise generated when the rack bar constituting the door opening device hits the door may be minimized.

The present disclosure is intended to propose a refrigerator in which a rack cover constituting the door opening device is prevented from tearing.

The present disclosure is intended to propose a refrigerator in which the door opening device is applicable even when the front-to-rear width (thickness) of the door is small.

The present disclosure is intended to propose a refrigerator in which accurate movement of the rack bar is possible even when the front-to-rear length of the rack bar constituting the door opening device is longer than the front-to-rear length of a housing.

The present disclosure is intended to propose a refrigerator in which the door opening device may be installed to be turned upside down regardless of the installation position thereof to be used in common.

The present disclosure is intended to propose a refrigerator in which the door opening device may be installed inside the upper surface of a cabinet such that design of the exterior of a refrigerator may be improved.

### Technical Solution

In order to achieve the above objectives, a refrigerator of the present disclosure may have the following characteristics.

The refrigerator of the present disclosure may include a door opening device which assists in opening a door. Accordingly, the door may be automatically opened or an opening force of the door may be reduced when opening the door.

According to the present disclosure, the door opening device may include a housing constituting an exterior thereof. Accordingly, the door opening device may be treated separately from other components of the refrigerator.

According to the present disclosure, the housing may be configured to have a front-to-rear length longer than a left-to-right width. Accordingly, a rack bar may be configured to have a sufficient front-to-rear length such that the door can be opened.

According to the present disclosure, the housing may be provided with a plurality of fastening parts. Accordingly, the housing may be selectively removed from or fastened to a cabinet.

According to the present disclosure, the door opening device may include the rack bar moved forward and rearward by driving force of a drive source.

According to the present disclosure, the rack bar may be configured such that the front end of the rack bar passes through the front surface of the housing and selectively protrudes toward the door.

According to the present disclosure, the fastening parts of the housing may be disposed respectively at positions symmetrical to each other in left and right directions relative to the center of the housing.

According to the present disclosure, the rack bar may be disposed within preset distances in left and right directions relative to the center of the housing.

According to the present disclosure, the rack bar may be located at the center portion of the housing.

According to the present disclosure, the rack bar may be installed to move in forward and rearward directions regardless of the opening angle of the door.

According to the present disclosure, in a state in which the door is closed, the door opening device may be disposed closer to the center of the cabinet than a hinge of the door.

According to the present disclosure, at least a portion of the rear surface of the housing may be open such that the rear end of the rack bar may pass through the open portion.

According to the present disclosure, a rack gear may be formed on any one side surface of the rack bar.

According to the present disclosure, the door opening device may include at least one power transmission gear.

According to the present disclosure, the power transmission gear may be located on any one side of the housing relative to the rack bar.

According to the present disclosure, the drive source may be located at the same side as a side at which the power transmission gear is located in opposite sides of the housing.

According to the present disclosure, an avoiding end may be formed on another side of the housing by vertically passing therethrough.

According to the present disclosure, the housing may include a lower base in which at least any one of the drive source and the power transmission gear is installed.

According to the present disclosure, an upper cover which covers the upper surface of the lower base may be included.

According to the present disclosure, a fastening hole may be formed in the lower base so as to install a motor.

According to the present disclosure, the fastening hole may be configured to be located by avoiding the power transmission gear.

According to the present disclosure, a guide groove may be formed in the upper cover so as to support the forward and rearward movements of the rack bar.

According to the present disclosure, an exposure hole may be formed in any one portion of the inside of the guide groove such that at least a portion of the power transmission gear is exposed through the exposure hole.

According to the present disclosure, a rack cover which closes the open upper surface of the guide groove may be provided.

According to the present disclosure, a holding groove may be formed along a front-to-rear direction in at least any one outer surface of the rack bar.

According to the present disclosure, a limiting protrusion received in the holding groove of the rack bar may be formed on at least any one portion of the bottom surface of the inside of the guide groove and the lower surface of the rack cover. Accordingly, forward moving distance of the rack bar may be limited.

According to the present disclosure, a protrusion limiting part which limits forward and rearward moving distances of the rack bar may be provided.

According to the present disclosure, the protrusion limiting part may be formed on at least any one portion of opposing portions between the rack bar and the housing.

According to the present disclosure, the protrusion limiting part may include a stopper protrusion formed on any one portion of the rack bar and the housing, and a support jaw formed on another portion.

According to the present disclosure, the protrusion limiting part may include a magnet installed on any one portion of the rack bar and the housing and a Hall sensor installed on another portion thereof.

According to the present disclosure, a rack head may be rotatably installed on the front end of the rack bar.

According to the present disclosure, a head cover which comes into contact with the door may be provided on the outer surface of the rack head. Accordingly, when the head cover is damaged, only the head cover may be replaced.

According to the present disclosure, the rack head may be configured to have rigidity greater than the rigidity of the head cover. Accordingly, frequent damage to the rack head may be prevented.

According to the present disclosure, the rack head may be installed to be rotated left and right by a rotating pin vertically passing through the front end of the rack bar.

According to the present disclosure, at least a portion of the upper and lower surfaces of the head cover may be configured to cover the rotating pin. Accordingly, the rotating pin may be prevented from being unintentionally loosened and removed.

According to the present disclosure, the rotating pin may be disposed on the centerline of the housing. Accordingly, the head cover may always be located on the centerline of the housing regardless of whether the housing is turned upside down.

According to the present disclosure, a manipulation panel may be provided on the front surface of the cabinet.

According to the present disclosure, the door opening device may be located behind the manipulation panel. Accordingly, the exposed portion of the door opening device to the outside may be minimized.

According to the present disclosure, the manipulation panel may include a protruding hole through which the rack bar passes. Accordingly, the movement of the rack bar pushing the door through the manipulation panel may be performed.

According to the present disclosure, the support jaw may be formed in the periphery of the protruding hole by being recessed therefrom. Accordingly, the head cover installed on the front end of the rack bar may be received in the surface of the manipulation panel.

According to the present disclosure, a support rib seated on the support jaw may be formed on the head cover by protruding therefrom. Accordingly, the problem that the head cover is excessively moved rearward and passes through the manipulation panel may be prevented.

According to the present disclosure, the fastening parts of the housing may include a second fastening part formed on the rear surface of the housing by being recessed forward therefrom. Accordingly, an associated object to be fastened may be received in the second fastening part while the housing is moved rearward.

According to the present disclosure, the fastening parts of the housing may include a first fastening part formed vertically through the front end of the housing.

According to the present disclosure, the first fastening part may be provided with a fastening end fastened to the front surface of the cabinet. Accordingly, the front surface of the housing may be fastened to the front surface of the cabinet.

According to the present disclosure, the fastening end may be formed to be removable from the first fastening part. Accordingly, the door opening device may be used in common for various types of refrigerators.

According to the present disclosure, a receiving groove may be formed in the front surface of the cabinet by being recessed therefrom such that the door opening device is received in the receiving groove. Accordingly, the door opening device may be prevented from being exposed to the outside of the cabinet.

According to the present disclosure, the receiving groove may be located behind the manipulation panel. Accordingly, a remaining portion except for a portion of the door opening device may be prevented from being exposed to the outside.

According to the present disclosure, the door opening device may be provided between an outer casing and an inner casing.

### Advantageous Effects

The refrigerator of the present disclosure described above may provide the following various effects due to the improvement of the door opening device.

In the door opening device of the refrigerator according to the present disclosure, due to the structural improvement of a motor seating part of the housing (for example, the position of the fastening hole or the provision of an avoiding jaw), the vertical height of the door opening device may be decreased as much as possible, thereby reducing the entire thickness of the door opening device.

In the door opening device of the refrigerator according to the present disclosure, a portion of the rear surface of the housing in which the rack bar is located may be formed to be open. Accordingly, the rack bar may be configured to have a sufficiently long length, and thus may operate such that the door is opened by a predetermined distance or more regardless of the type (a front-to-rear width) of a refrigerator or a door.

In the door opening device of the refrigerator according to the present disclosure, the head cover made of a soft material may be provided, thereby reducing contact noise generated when the rack bar hits the door.

In the door opening device of the refrigerator according to the present disclosure, instead of the head cover, the rack head may be coupled rotatably to the rack bar, thereby preventing damage to the rack head.

The door opening device of the refrigerator according to the present disclosure may have the avoiding end formed on any one side of the housing and may be configured to be installed to be turned upside down regardless of installation position of the door opening device. Accordingly, the door opening device may be properly installed according to the structure or shape of an installation portion thereof, and may be used in common regardless of the model of the refrigerator.

In the door opening device of the refrigerator according to the present disclosure, the fastening parts of the housing may be disposed respectively at positions symmetrical to each other in left and right directions relative to the center of the housing. Accordingly, the housing may be installed to be turned upside down.

The door opening device of the refrigerator according to the present disclosure may be commonly applied to both a structure in which the door opening device is installed to be placed on the upper surface of the cabinet and a structure in which the door opening device is installed while being inserted into the cabinet.

The door opening device of the refrigerator according to the present disclosure may minimize a portion thereof exposed to the outside due to the manipulation panel.

### DESCRIPTION OF DRAWINGS

FIG. 1 is a perspective view of the appearance of a refrigerator according to the present disclosure.

FIG. 2 is a top plan view of the refrigerator according to the present disclosure.

FIG. 3 is a view illustrating a state in which a refrigerator-door opening device according to the present disclosure is installed.

FIGS. 4 and 5 are views illustrating each state in which the door opening device of the refrigerator according to the present disclosure is installed according to opening direction of a door.

FIG. 6 is a front perspective view illustrating the door opening device of the refrigerator according to the present disclosure.

FIG. 7 is a rear perspective view of a state in which a rack cover is removed from the door opening device of the refrigerator according to the present disclosure.

FIG. 8 is a rear perspective view of a state in which the rack cover and a rack bar are removed from the door opening device of the refrigerator according to the present disclosure.

FIG. 9 is a top plan view illustrating the door opening device of the refrigerator according to the present disclosure.

FIG. 10 is a sectional view taken along line [symbol] f FIG. 9.

FIG. 11 is a top plan view of a state in which the rack cover is removed from the door opening device of the refrigerator according to the present disclosure.

FIG. 12 is a bottom view of the door opening device of the refrigerator according to the present disclosure.

FIG. 13 is a view illustrating a state in which the rack bar, the drive source, and a power transmission gear are installed on a lower base of the door opening device of the refrigerator according to the present disclosure.

FIG. 14 is a top plan view of the lower base of the door opening device of the refrigerator according to the present disclosure.

FIG. 15 is a top plan view of a state in which the power transmission gear is installed on the lower base of the door opening device of the refrigerator according to the present disclosure.

FIG. 16 is an exploded perspective view of the rack bar of the door opening device of the refrigerator according to the present disclosure.

FIG. 17 is a top plan view of the rack bar of the door opening device of the refrigerator according to the present disclosure.

FIG. 18 is a perspective view of a rack head of the door opening device of the refrigerator according to the present disclosure.

FIG. 19 is a top plan view of a state in which the rack head is installed on the rack bar of the door opening device of the refrigerator according to the present disclosure.

FIG. 20 is a bottom view of a state in which the rack head is installed on the rack bar of the door opening device of the refrigerator according to the present disclosure.

FIGS. 21 and 22 are views illustrating the operation states of the rack head installed the rack bar of the door opening device of the refrigerator according to the present disclosure.

FIG. 23 is a view illustrating a coupling relation between the rack bar and the rack head in the door opening device of the refrigerator according to the present disclosure.

FIG. 24 is a first side view illustrating the coupling relation between the rack bar and the rack head in the door opening device of the refrigerator according to the present disclosure.

FIG. 25 is a cross-sectional view taken along line II-II of FIG. 24.

FIG. 26 is a second side view illustrating the coupling relation between the rack bar and the rack head in the door opening device of the refrigerator according to the present disclosure.

FIG. 27 is a cross-sectional view of a state in which the door opening device of the refrigerator according to the present disclosure is installed on a cabinet.

FIG. 28 is a cross-sectional view of the rack cover of the door opening device of the refrigerator according to the present disclosure.

FIG. 29 is a top plan view illustrating the coupling relation between the rack bar and the rack head in the door opening device of the refrigerator according to the present disclosure.

FIG. 30 is a sectional view taken along line II-III of FIG. 29.

FIG. 31 is a sectional view taken along line IV-IV of FIG. 29.

FIG. 32 is an enlarged view illustrating the coupling relation between the rack bar and the rack cover in relation to a protrusion limiting part of the door opening device of the refrigerator according to the present disclosure.

FIGS. 33 to 46 are views and enlarged views sequentially illustrating the operation states of the door opening device of the refrigerator according to the present disclosure.

FIGS. 47 and 48 are perspective views of an example of the installation position of the door opening device of the refrigerator according to the present disclosure.

FIG. 49 is a cross-sectional view of an example of the installation position of the door opening device of the refrigerator according to the present disclosure.

FIG. 50 is a view illustrating the state of an example of the fastening end of the door opening device of the refrigerator according to the present disclosure.

FIG. 51 is a perspective view of another example of the installation position of the door opening device of the refrigerator according to the present disclosure.

FIGS. 52 to 54 are side views of each embodiment of a coupling structure between the rack bar and the rack head in the door opening device of the refrigerator according to the present disclosure.

### MODE FOR INVENTION

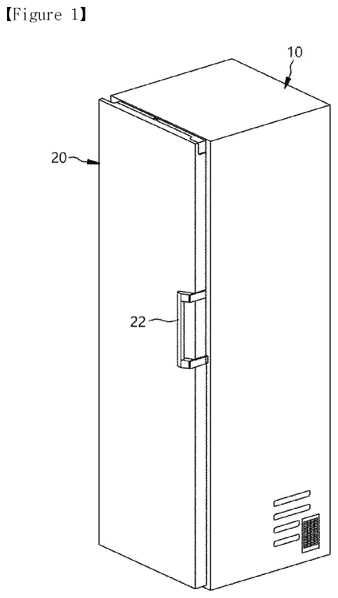

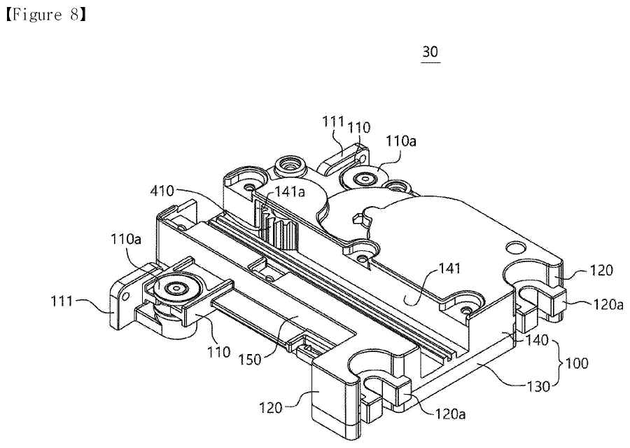

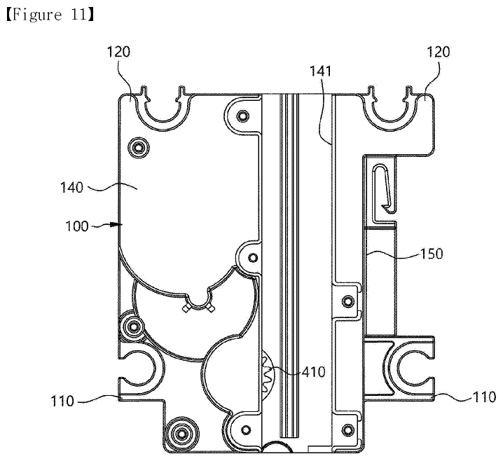

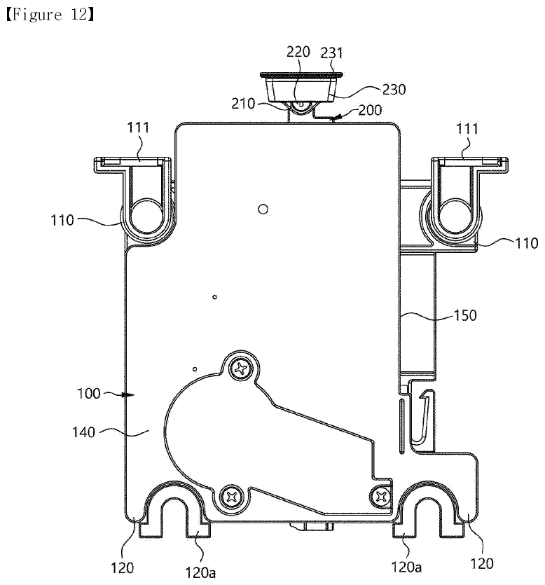

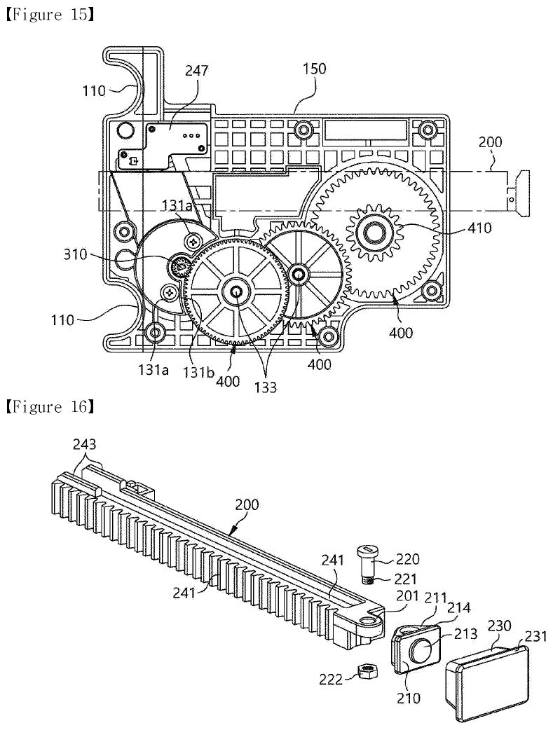

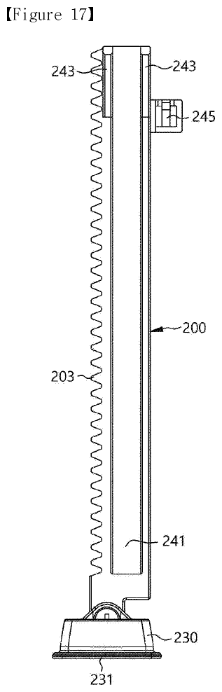

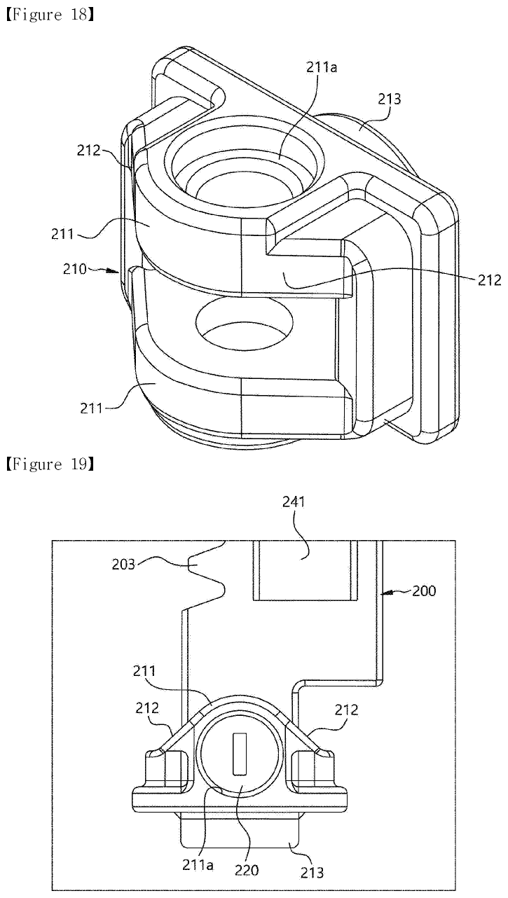

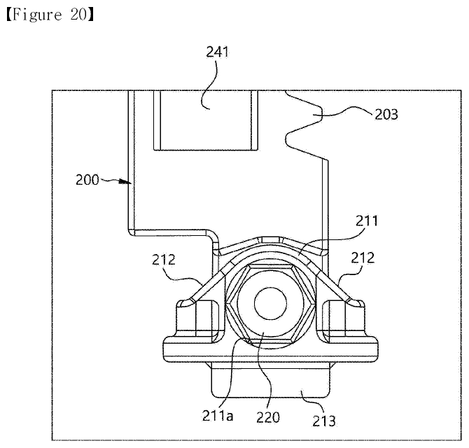

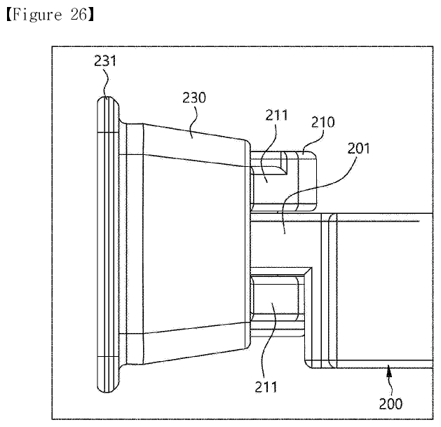

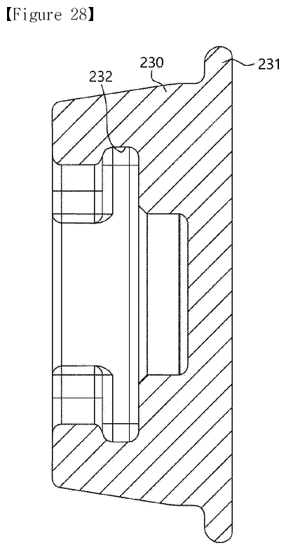

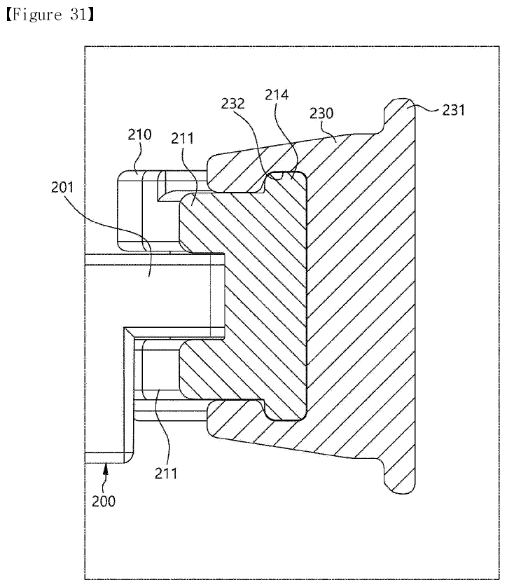

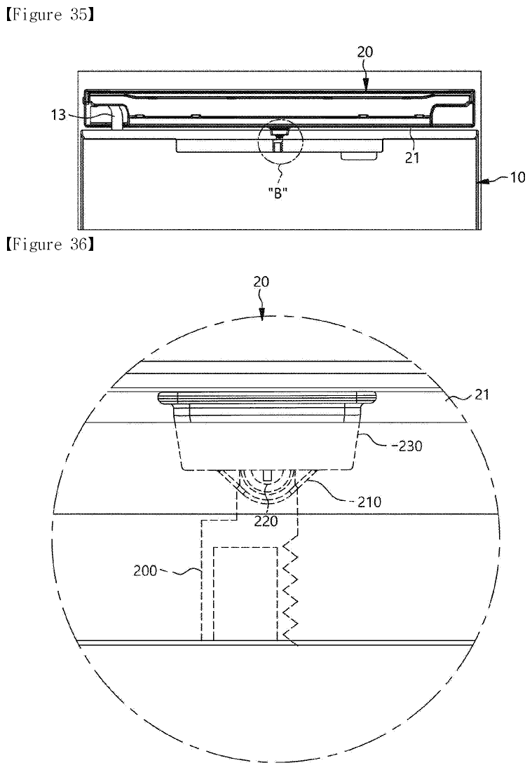

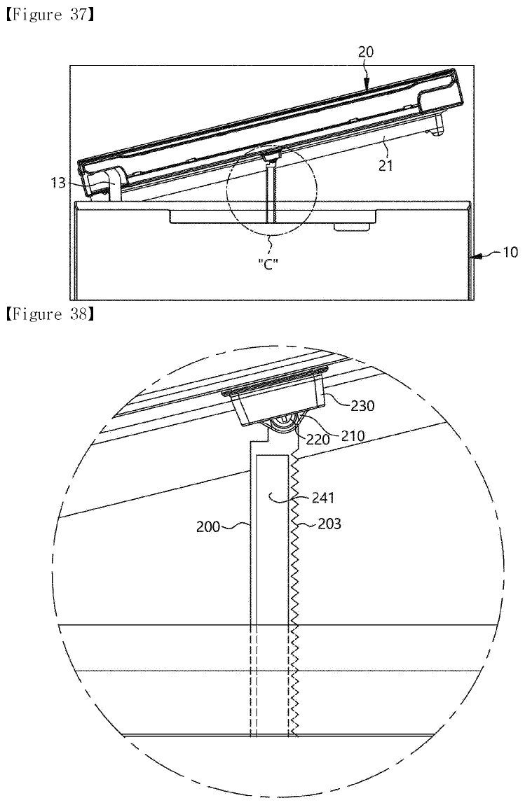

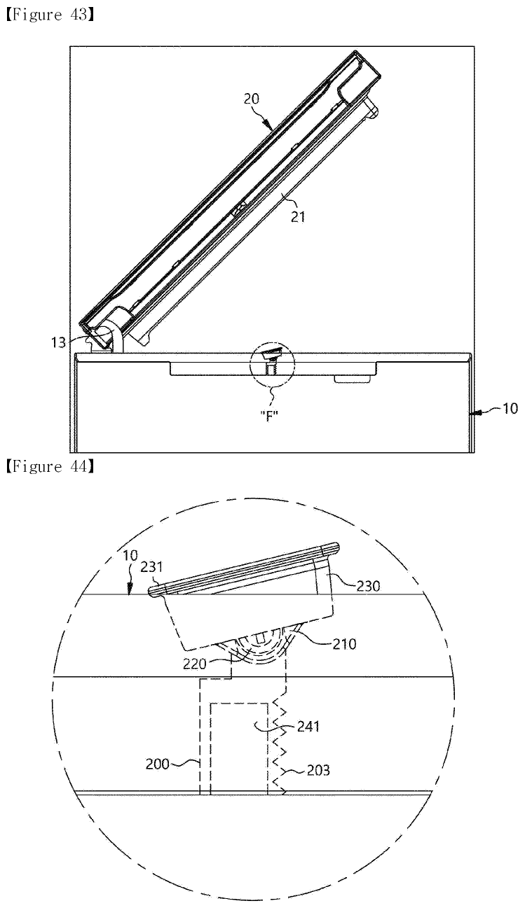

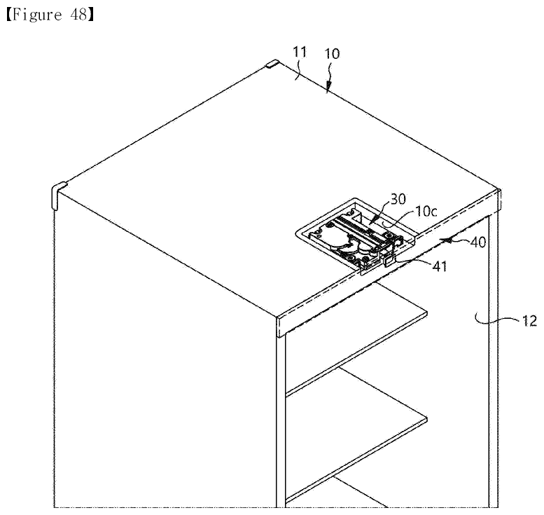

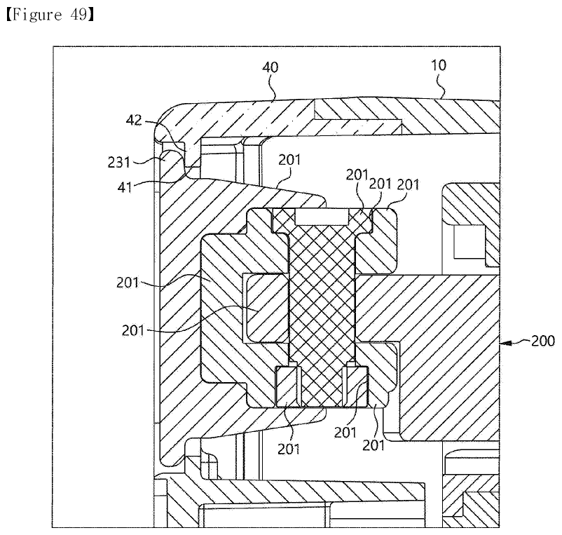

Hereinafter, the exemplary embodiment of a refrigerator of the present disclosure will be described with reference to FIGS. 1 to 54.

Prior to description, the refrigerator of the present disclosure may include a door opening device. Particularly, the door opening device may be designed to have a structure that can be installed upside down.

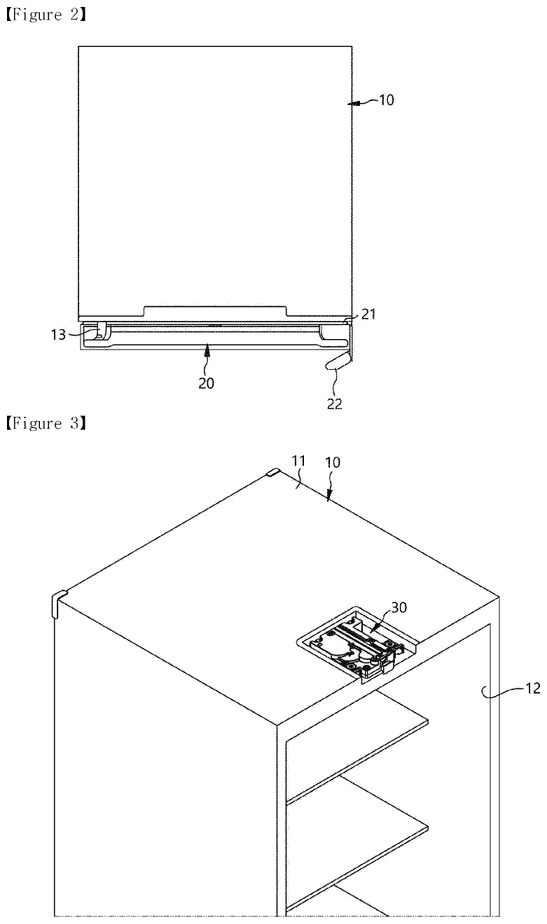

FIG. 1 illustrates the exterior of the refrigerator according to the embodiment of the present disclosure, FIG. 2 illustrates the state of a top plan side of the refrigerator according to the embodiment of the present disclosure, and FIG. 3 illustrates a state in which the refrigerator-door opening device according to the embodiment of the present disclosure is installed.

According to these drawings, the refrigerator according to the embodiment of the present disclosure may include a cabinet 10.

The cabinet 10 may be the body of the refrigerator, may be formed as a single box body, or may be formed as a structure in which a plurality of box structures are overlapped.

For example, as illustrated in FIG. 3, the cabinet 10 may include an outer casing 11 constituting the exterior of the refrigerator 1.

The cabinet 10 may include an inner casing 12 constituting the inner wall surface of the refrigerator 1. Such an inner casing 12 may be formed in a box shape having an open front surface, and may have a storage compartment provided therein such that items are stored in the storage compartment. The storage compartment may include one storage compartment or at least two storage compartments.

The inner casing 12 may be installed inside the outer casing 11. In this case, the upper wall of the inner casing 12 and the upper wall of the outer casing 11 may be installed to be spaced apart from each other. Empty space may be defined between the two upper walls. Although not shown, a filler may be filled between the two upper walls, and at least a portion of the two upper walls may be configured to be in contact with each other.

The refrigerator according to the embodiment of the present disclosure may include a door 20 which opens and closes the storage compartment.

The door 20 may be rotatably installed on the cabinet 10.

For an example, as illustrated in FIG. 2, the cabinet 10 may be provided with a hinge 13, and the door 20 may be rotatably installed on the hinge 13 of the cabinet 10. In this case, a first end of the hinge 13 may be connected to the cabinet 10, and a second end thereof may be connected to the door 20.

Meanwhile, the door 20 may include only one door, or may include at least two doors. For example, the door 20 may include at least one door provided for each storage compartment.

In the following embodiments and related drawings, a refrigerator in which the storage compartment is opened and closed by one door 20 is exemplified.

A handle 22 may be provided on the door 20 so as to open and close the door 20.

The refrigerator according to the embodiment of the present disclosure may include the door opening device 30 which assists in opening the door 20.

That is, as in the embodiments of the present disclosure, a larger door may be provided when opening and closing one storage compartment with one door than when opening and closing one storage compartment with a plurality of doors 20.

Accordingly, as the size of the door 20 increases, adhesion between the door 20 and the cabinet 10 may be required to increase to prevent leakage of cold air, and a greater force may be required to open the door 20.

In consideration of this, due to the provision of the door opening device 30, the door 20 may be automatically opened or an opening force of the door 20 may be reduced during the opening of the door 20.

Such a door opening device 30 may be provided as a single assembly separate from the cabinet 10 or the door 20. That is, the door opening device 30 may be provided as a single assembly for easy storage and handling.

The door opening device 30 may be installed on the cabinet 10 and may be configured to push the door 20 when opening the door 20. That is, when the door opening device 30 is installed in the door 20, there is a design limitation due to a narrow installation space. In consideration of this, the door opening device 30 is installed in the cabinet 10 such that the installation space can be secured as much as possible, thereby eliminating design limitations.

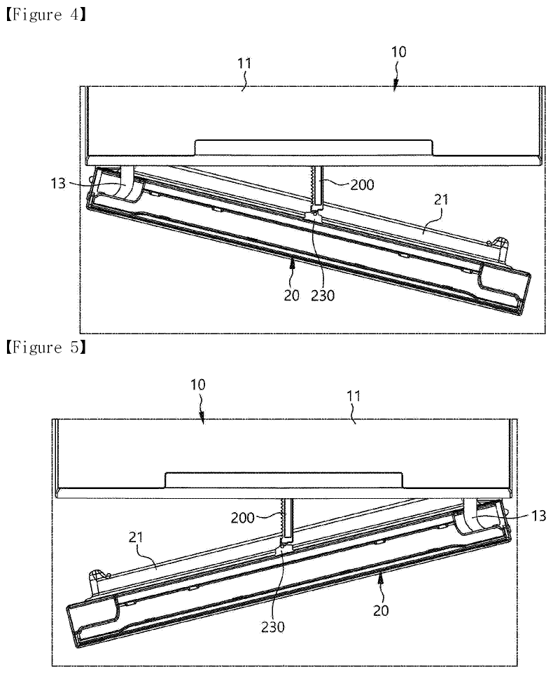

According to a user's request, the door 20 may be divided into a door installed to have a structure which is opened at the right side (see FIG. 4) by locating the hinge 13 on the left side of the cabinet 10 and a door installed to have a structure which is opened at the left side (see FIG. 5) by locating the hinge 13 on the right side of the cabinet 10.

To this end, the door opening device 30 may be configured to be installed upside down and used according to the opening direction of the door 20. That is, the door opening device 30 may be configured to be turned around left and right according to a door having each opening structure. Accordingly, the door opening device 30 may be used in common regardless of the installation position of the hinge 13 according to the opening direction of the door 20 (the door having structure which the door is opened at the left side or the door having structure which the door is opened at the right side).

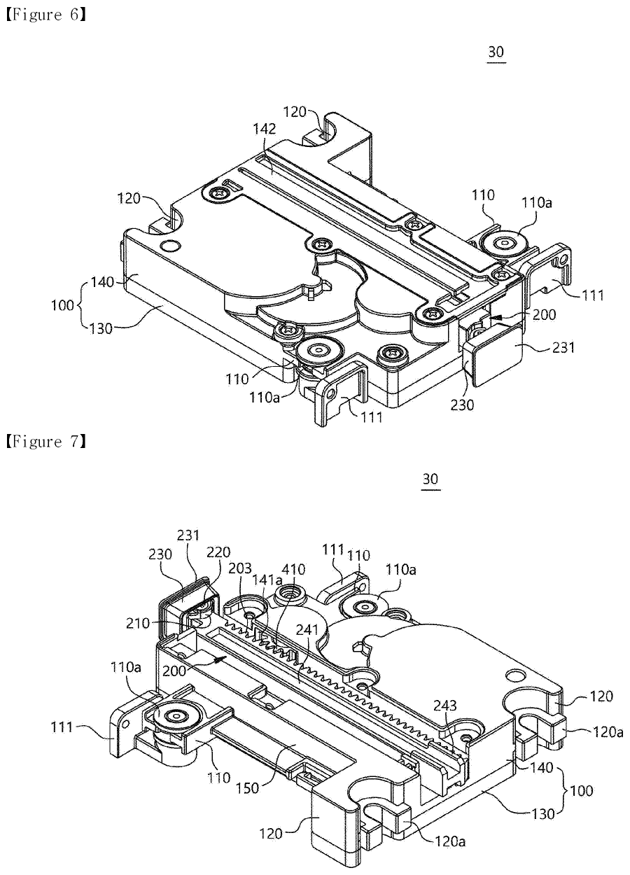

Each component of the door opening device 30 will be described in more detail with reference to FIGS. 6 to 30.

First, the door opening device 30 may include a housing 100 constituting an exterior thereof. Accordingly, the door opening device 30 may be treated as an assembly separate from other components of the refrigerator (for example, the cabinet or the door, etc.).

As in each embodiment of the housing 10 of FIGS. 6 to 15, the housing 100 may be configured to have various structures.

According to the embodiment of the housing 100, the housing 100 may be configured to have a front-to-rear length longer than a left-to-right width. Due to such a structure, a rack bar 200 may be configured to have an entire length as long as possible, and thus the door 20 may be opened by a sufficient distance. For example, as for a type of refrigerator having only one door 20, the door opening device 30 is not installed at a position near the hinge 13 of the door 20, but may be installed to push the center portion of the door 20.

According to another embodiment of the housing 100, the housing 100 may be provided with a plurality of fastening parts 110 and 120 so as to be coupled to the cabinet 10. Accordingly, the housing 100 may be selectively fastened to the cabinet 10, or may be selectively removed from the cabinet 10.

The fastening part may include a first fastening part 110. The first fastening part 110 may be formed vertically through the front end of the housing 100. When coupling the door opening device 30 to the upper surface of the cabinet 10 in a vertical direction, such a first fastening part 110 may be used to fasten the associated the door opening device 30.

For example, the first fastening part 110 may include two first fastening parts, and the two first fastening parts may be located respectively on the opposite edges of the front end of the housing 100. Particularly, the two first fastening parts 110 may be disposed respectively at positions symmetrical to each other in left and right directions relative to the center of the housing 100. The two first fastening parts 110 may be disposed respectively at positions symmetrical to each other in left and right directions relative to the rotation center of a rack head 210.

The fastening part may include a second fastening part 120. The second fastening part 120 may be formed on the rear surface of the housing 100 by being recessed forward therefrom. Such a second fastening part 120 may guide the housing 100 to a precise position thereof when moving the housing 100 rearward while inserting the housing 100 into the cabinet 10. For example, an associated object to be fastened may be provided in the cabinet 10 and may be received in the second fastening part 120 when moving the housing 100 rearward while inserting the housing 100 into the cabinet. When applied to a structure in which the door opening device 30 is coupled to the upper surface of the cabinet 10, the second fastening part 120 may allow the rear end portion of the housing 100 to be fastened to the cabinet 10 by a bolt.

The second fastening part 120 may include two second fastening parts, and the two second fastening parts may be located respectively on the opposite edges of the rear surface of the housing 100. In this case, the two second fastening parts 120 may be disposed respectively at positions symmetrical to each other in left and right directions relative to the center of the housing 100. The two second fastening parts 120 may be disposed respectively at positions symmetrical to each other in left and right directions relative to the rotation center of the rack head 210.

The fastening parts 110 and 120 may be provided with cushion members 110a and 120a, respectively. Due to each of the cushion members 110a and 120a, when a bolt is fastened to each of the fastening parts 110 and 120, a contact portion of each of the fastening parts with the bolt may be protected, and the fastening may be securely performed.

According to still another embodiment of the housing 100, the housing 100 may include a lower base 130 provided as a bottom part. That is, the lower base 130 may be configured as the bottom of the housing 100.

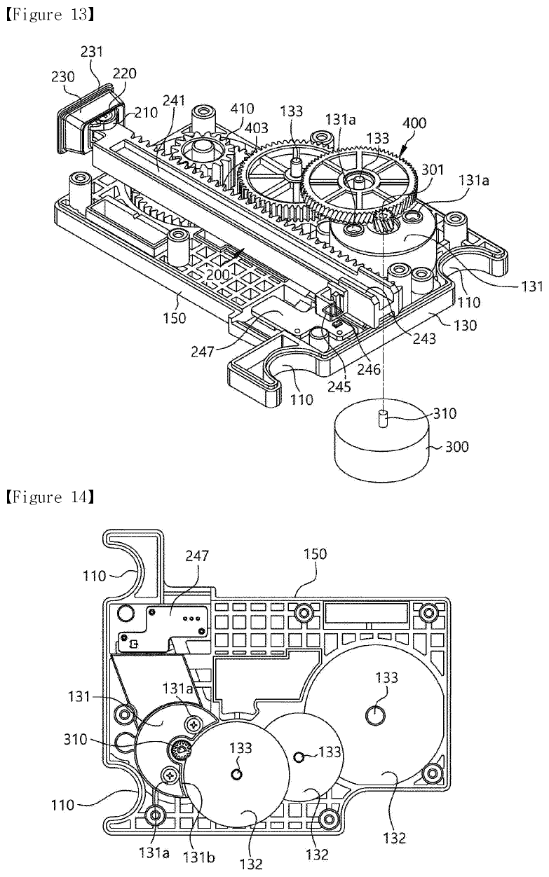

As illustrated in FIGS. 13 to 15, a motor seating part 131 in which a drive source 300 is installed may be formed in the lower base 130. For example, the motor seating part 131 may be formed to have a cylindrical shape which has an open lower surface and a closed upper surface and protrudes upward. The drive source 300 may be configured to be inserted from the open lower surface of the motor seating part 131 into the motor seating part 131 to be seated therein. In this case, the center portion of the closed upper surface of the motor seating part 131 may be configured to be open such that a drive shaft 310 of the drive source 300 protrudes.

At least one fastening hole 131a may be formed in the closed upper surface of the motor seating part 131 such that the motto seating part is screwed to the drive source 300. Particularly, the fastening hole 131a may be formed to be located by avoiding a power transmission gear 400.

An avoiding jaw 131b may be formed on the closed upper surface of the motor seating part 131. The avoiding jaw 131b may be configured to be stepped from the upper surface of the motor seating part 131. That is, by forming the avoiding jaw 131b on the upper surface of the motor seating part 131, at least a portion of the power transmission gear 400 may be located on the upper side of the avoiding jaw 131b. Accordingly, the entire height of the door opening device 30 may be decreased by the height of the avoiding jaw 131b.

At least one gear seating part 132 in which at least one power transmission gear 400 is installed may be formed in the lower base 130. For example, the gear seating part 132 may be formed by being depressed from the upper surface of the lower base 130.

The lower base 130 may be provided with a rotation support shaft 133 which supports the at least one power transmission gear 400. That is, the center of the shaft of each power transmission gear 400 may be installed to pass through the rotation support shaft 133 of the lower base 130 and thus the shaft may be supported by the rotation support shaft 133 to be rotated. Although not shown, at least one rotation support shaft 133 may be formed in an upper cover 140.

According to still another embodiment of the housing 100, the housing 100 may include the upper cover 140 (see FIGS. 6 to 11) provided as an upper surface thereof. That is, the upper cover 140 may be configured as the upper surface of the housing 100.

For an example, the upper cover 140 may be configured to cover the upper surface of the lower base 130. Particularly, the upper cover 140 may be configured to cover each of the power transmission gears 400 installed in the lower base 130.

For another example, a guide groove 141 supporting the forward and backward movements of the rack bar 200 may be formed in the upper cover 140. In this case, the guide groove 141 may be formed along the front-to-rear direction of the upper cover 140.

The front surface of the guide groove 141 may be configured to be open. Accordingly, the rack bar 200 may protrude forward through the open front surface of the guide groove 141.

The rear surface of the guide groove 141 may be configured to be open. Accordingly, the rack bar 200 may be configured to have length longer than the length of the housing 100, and the door 20 may be opened more by the longer length of the rack bar 200. Of course, even when the guide groove 141 is not formed in the housing 100, a portion, which is located behind the rack bar 200, of the rear surface of the housing 100 may be configured to be open.

The upper surface of the guide groove 141 may be configured to be open. Accordingly, it is possible to install the rack bar 200 by inserting the rack bar 200 into the guide groove 141 from the open top surface of the guide groove 141.

An exposure hole 141a may be formed in any one side wall of the inside of the guide groove 141 such that at least a portion of the power transmission gear 400 is exposed through the exposure hole. In this case, the power transmission gear 400 exposed through the exposure hole 141a may be a pinion gear 410 engaged with the rack bar 200.

The open upper surface of the guide groove 141 may be closed by a rack cover 142. Accordingly, the rack bar 200 received in the guide groove 141 may be prevented from being unintentionally removed upward.

Meanwhile, two first fastening parts 110 provided in the housing 100 may be formed in the upper cover 140. The two second fastening parts 120 may be partially divided to be formed in the upper cover 140 and the lower base 130. This is illustrated in the embodiment.

Only at least any one of the fastening parts 110 and 120 may be formed in the upper cover 140 or in the lower base 130. Alternatively, all of the fastening parts 110 and 120 may be formed in the upper cover 140 or in the lower base 130.

According to still another embodiment of the housing 100, an avoiding end 150 which is open vertically may be formed in a portion of portions of the housing 100 on any one side relative to the position of the rack bar 200.

The avoiding end 150 may be formed to be more recessed inward than a portion of another side of the housing 100. For example, multiple components may be located at any one side of the housing 100, and the avoiding end 150 may be formed at another side thereof. Accordingly, according to environment provided by the installation portion of the door opening device 30, the housing 100 may be installed upside down.

For an example, when there is a structure for power connection or installation of other structures at any one side of the cabinet 10 relative to the position of the rack bar 200, the avoiding end 150 may be installed to be located at an associated portion.

For another example, when there is a structure for power connection or installation of other structures at another side of the cabinet 10 relative to the position of the rack bar 200, the door opening device 30 may be installed upside down such that the avoiding end 150 is located at an associated portion.

Next, the door opening device 30 may include the rack bar 200 which pushes the door 20.

Such a rack bar 200 may receive driving force of the drive source 300 and may move forward and rearward from the housing 100.

FIGS. 16 to 31 illustrate the structure of each portion in relation to the rack bar 200. With reference to this, the rack bar 200 will be described in more detail.

The rack bar 200 may be formed as a long bar in a front-to-rear direction.

The front-to-rear length of the rack bar 200 may be shorter than, the same as, or longer than the front-to-rear length of the housing 100. The front-to-rear length of such a rack bar 200 may be determined or selected by considering an opening angle of the door 20 according to the size of the door 20 or a protruding length of the rack bar in consideration of the installation position of the door opening device 30.

The front end of the rack bar 200 may selectively protrude toward the door 20 by passing through the front surface of the housing 100.

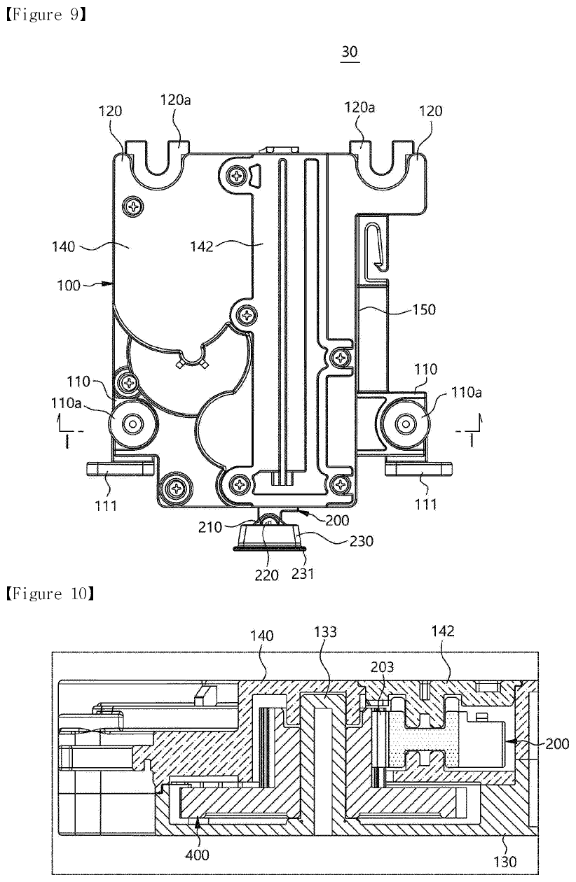

As illustrated in FIG. 9, the rack bar 200 may be located at the center portion of the housing 100. The center portion may fall within preset left and right distances from the front center of the housing 100. The preset left and right distances may be preset as a distance that considers the amount of change in a pressing force generated due to the eccentricity of the rack bar 200 when the door opening device 30 is turned upside down. That is, the preset left and right distances may be determined such that the amount of change of the pressing force is as small as possible.

Meanwhile, various structures may be installed or formed in the rack bar 200.

According to the embodiment of the rack bar 200, the rack head 210 may be rotatably installed on the front end of the rack bar 200.

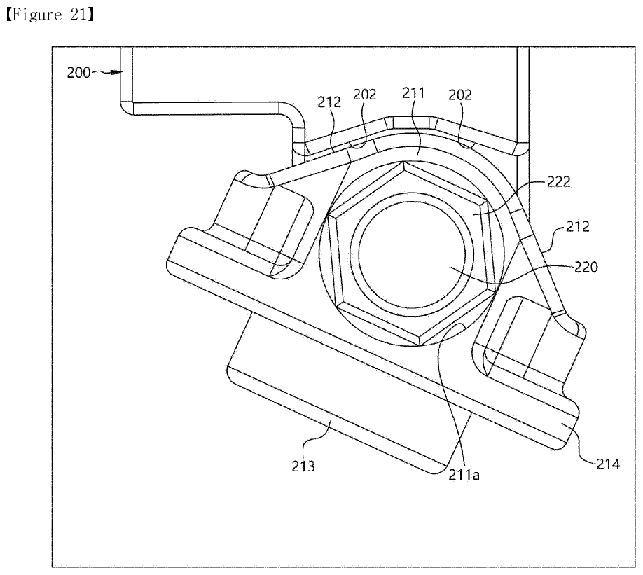

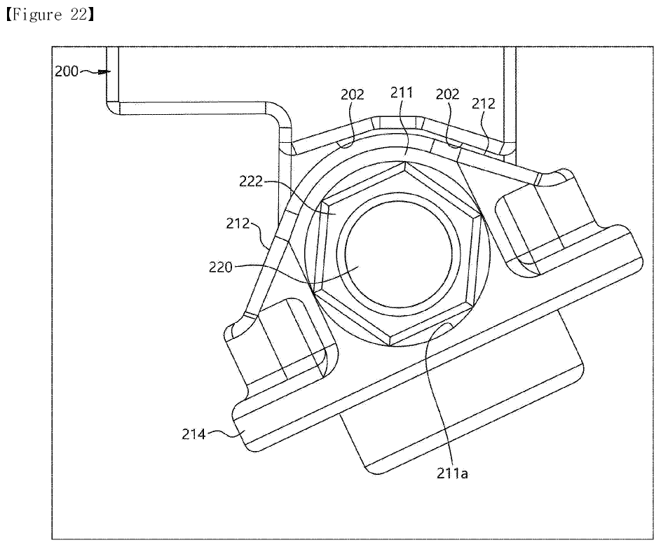

The rack head 210 may be installed to include a first rotation range in which the rack head can rotate to any one side from the front end of the rack bar 200 (see FIG. 21), and a second rotation range in which the rack head can rotate to another side from the front end of the rack bar 200 (see FIG. 22). The first rotation range may be preset as the rotation range of the door having the structure which the door is opened at the left side. The second rotation range may be preset as the rotation range of the door having the structure which the door is opened at the right side. For example, the rack head 210 may be configured to rotate to any one side in the first rotation range, and to rotate to another side in the second rotation range. The first rotation range and the second rotation range may be preset to be the same or different from each other.

Two first ribs 211 through which a rotating pin 220 passes may be formed in the rack head 210. The two first ribs 211 may be disposed to be spaced vertically apart from each other. The second rib 201 formed by protruding from the front end (for example, a front surface) of the rack bar 200 may be inserted into space between the two first ribs 211 of the rack head 210. Although not shown, two second ribs 201 may be formed on the front end of the rack bar 200 by being spaced vertically apart from each other, and one first rib 211 inserted into space between the two second ribs 201 of the rack bar 200 may be formed on the rack head 210.

A stopper 202 may be formed on a surface of the second rib 201 (at least one of the upper and lower surfaces thereof) so as to prevent the first rib 211 from being rotated more than a preset angle (each rotation range). For example, the stopper 202 may be configured to be inclined along the inner periphery of the second rib 201. A rotation limiting jaw 212 may be formed on the periphery of the first rib 211 such that rotation of the rack head can be limited by the rotation limiting jaw hitting the stopper 202.

The end of the first rib 211 and the end of the second rib 201 may be configured to correspond to each other. For example, the first rib 211 of the rack head 210 and the second rib 201 of the rack bar 200 may be configured to be round so as not to interfere with the rotation of the rack head 210.

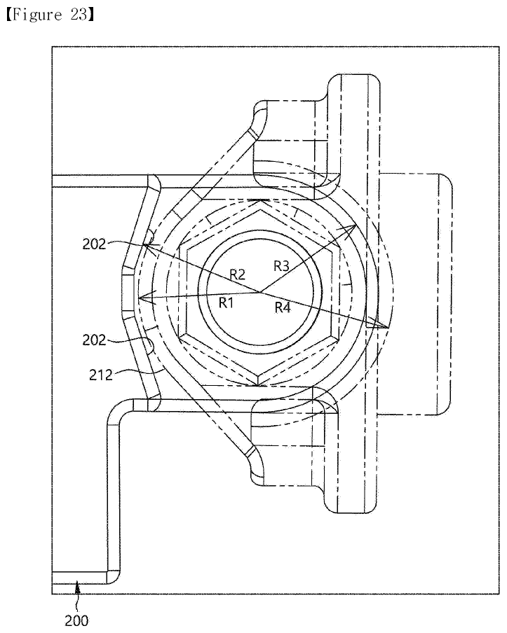

As illustrated in FIG. 23, a distance R1 between the rotation center of the first rib 211 and the round end of the first rib 211 may be shorter than a distance R2 between the rotation center of the second rib 201 and a portion at which the stopper 202 of the second rib 201 is located. Accordingly, the rotation of the first rib 211 relative to the rack bar 200 may be performed efficiently.

As illustrated in FIG. 23, a distance R3 between the rotation center of the second rib 201 and the round end of the second rib 201 may be shorter than a distance R4 between the rotation center of the first rib 211 and a portion on which the first rib is connected with the rack head 210. Accordingly, the rotation of the second rib 201 relative to the rack head 210 may be performed efficiently.

Each of the ribs 211 and 201 may be coupled to each other to rotate left and right due to the rotating pin 220 installed to sequentially pass through the ribs. In this case, the rotating pin 220 may be configured to have threads 221 formed on at least a portion thereof (for example, a portion of an end thereof) so as to be coupled to a nut 222. A portion of the rotating pin 220 passing through each rib 211 or 201 may not have threads so as to support the efficient rotation of the rotating pin.

A seating recess 211a may be formed to be recessed in each of the outer surface of any one first rib 211 (for example, the upper surface of an upper first rib) and the outer surface of another first rib 211 (for example, the lower surface of a lower first rib) such that each of the head of the rotating pin 220 and the nut 222 can be seated in the seating recess.

Meanwhile, a reinforcing rib 213 may be formed on the front surface of the rack head 210. The reinforcing rib 213 may be a structure provided to reinforce the rigidity of an associated portion due to a recessed structure between the two first ribs 211.

A holding protrusion 214 may be formed on the periphery of the front surface of the rack head 210. As illustrated in the drawings of the embodiment, the holding protrusion 214 may be formed along the entire periphery of the rack head 210. Although not shown, the holding protrusion 214 may be formed on only a portion of the periphery of the rack head 210 by protruding therefrom. The holding protrusion 214 may be received in a cover groove 232 formed in a head cover 230 to be described later.

The rotating pin 220 may be disposed on the centerline of the housing 100. Accordingly, the head cover 230 may be always located on the centerline of the housing 100 regardless of whether the door opening device 30 (or the housing) is turned upside down, and regardless of whether the door opening device 30 is upside down, the entire portion of the front surface of the head cover may be in contact with the door 20.

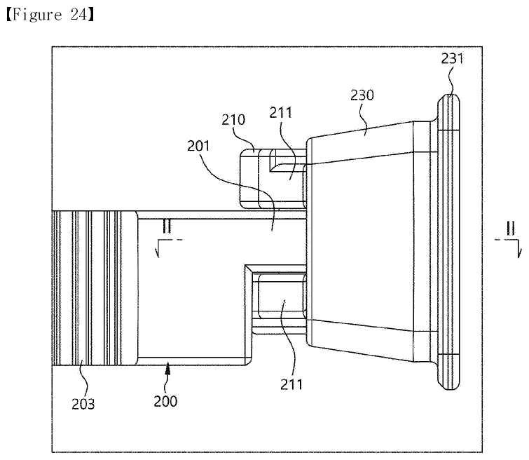

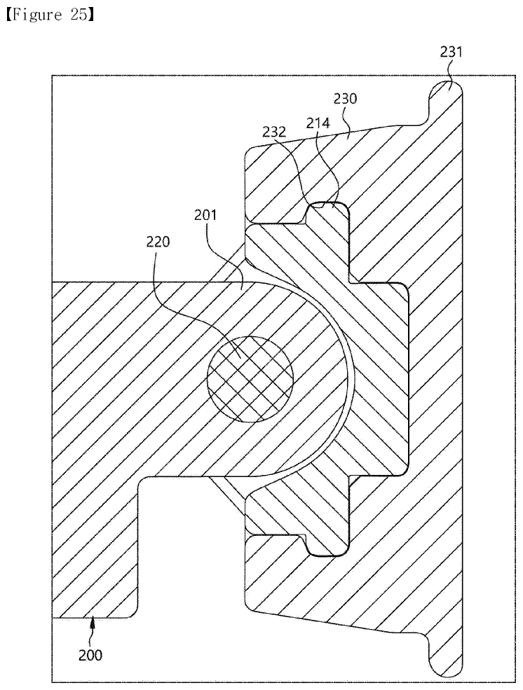

As illustrated in FIGS. 24 to 31, the head cover 230 coming into contact with the door 20 may be provided on the outer surface of the rack head 210. The rack head 210 may be formed to have rigidity greater than the head cover 230. For example, the rack head 210 may be formed of polyoxymethylene (POM), and the head cover 230 may be formed of a urethane material. Due to such a structure, when the head cover 230 is damaged, it is possible to replace only the head cover 230, and despite the frequent rotation of the rack head 210, the rack head 210 may be prevented from damage such as tearing or cracking.

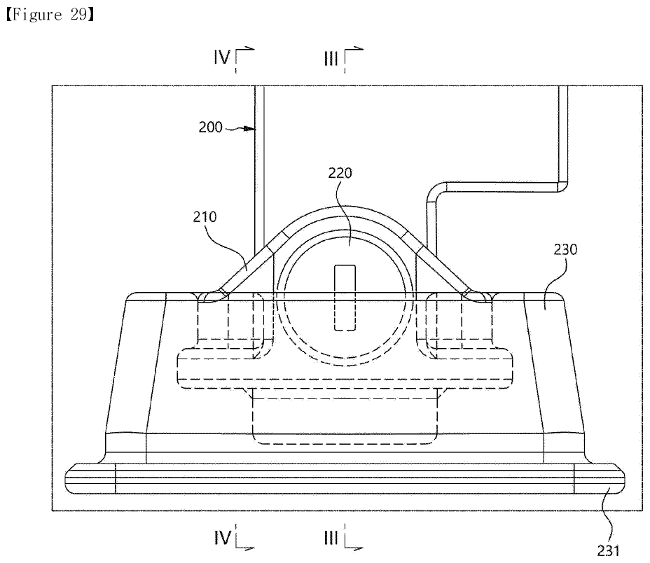

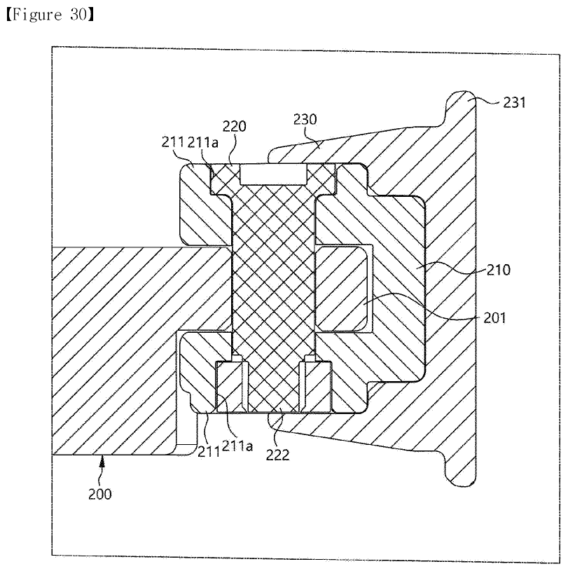

As illustrated in FIGS. 29 and 30, at least a portion of the upper and lower surfaces of the head cover 230 may be configured to cover the rotating pin 220. Preferably, a portion of the upper and lower surfaces of the head cover 230 may be configured to cover at least half of the rotating pin 220. Accordingly, the rotating pin 220 may be prevented from being unintentionally loosened and removed.

A support rib 231 may be formed on the periphery of the head cover 230. Such a support rib 231 may be a structure for preventing the head cover from being excessively moved rearward from the front surface of the cabinet 10 and may be formed on the periphery of the head cover 230 by protruding outward therefrom. A protruding hole 10a through which the head cover 230 protrudes may be formed in the cabinet 10, and a support jaw 10b by which the support rib 231 is supported may be formed along the inner periphery of the protruding hole 10a.

According to another embodiment of the rack bar 200, a rack gear 203 may be formed on any one side surface of the rack bar 200. The rack gear 203 may be configured to be engaged with the pinion gear 410 of the power transmission gear 400. That is, the rack bar 200 may be configured to receive power through a plurality of gears and be rectilinearly moved.

The pinion gear 410 may be exposed to the inside of the guide groove 141 through the exposure hole 141a formed in any one side wall of the inside of the guide groove 141, and the rack bar 200 may be installed to be engaged with the pinion gear 410 while the rack bar 200 is received in the guide groove.

According to still another embodiment of the rack bar 200, a protrusion limiting part may be provided on at least any one portion of opposing portions between the rack bar 200 and the housing 100 so as to limit the distance of each of the forward and rearward movements of the rack bar 200.

For an example, as illustrated in FIG. 32, the protrusion limiting part 240 may include a holding groove 241 and a limiting protrusion 242.

For example, the holding groove 241 may be formed by being recessed along the upper surface of the rack bar 200, and the limiting protrusion 242 received in the holding groove 241 may be formed on the lower surface of the front end of the rack cover 142. Accordingly, the backward moving distance of the rack bar 200 may be limited.

Although not shown, the holding groove 241 may be formed by being recessed along the lower surface of the rack bar 200, and the limiting protrusion 242 received in the holding groove 241 may be formed on the bottom surface of the inside of the guide groove 141.

For another example, as illustrated in FIG. 32, the protrusion limiting part 240 may include a stopper protrusion 243 and a support jaw 244.

For example, the stopper protrusion 243 may protrude on each of the opposite sides of the upper surface of the rear end of the rack bar 200, and the support jaw 244 may be formed on each of the opposite sides of the lower surface of the front end of the rack cover 142. Accordingly, the forward moving distance of the rack bar 200 may be limited.

For another example, as illustrated in FIG. 13, the protrusion limiting part may include a magnet 245 and a Hall sensor 246.

For example, the magnet 245 may be installed on the rear end of any one side wall of the rack bar 200, and a sensor PCB 247 having the Hall sensor 246 may be installed on a portion of the rear end of the housing (for example, the upper surface of the lower base). Accordingly, the backward moving distance of the rack bar 200 may be limited, and the forward or backward movement of the rack bar 200 may be determined.

Next, the door opening device 30 may include the drive source 300 that provides a driving force to forcibly move the rack bar 200.

As illustrated in FIG. 13, the drive source 300 may be installed in the motor seating part 131 of the lower base 130. In this case, the drive source 300 may be received in the motor seating part 131 through the open lower surface of the motor seating part 131.

The drive source 300 may have the drive shaft 310. The drive shaft 310 may be installed to penetrate through the center of the upper surface of the motor seating part 131 to be exposed to the upper side thereof so as to be engaged with any one power transmission gear 400.

The drive source 300 may be screwed to the motor seating part 131 through the fastening hole 131a formed in the motor seating part 131.

The drive source 300 may be configured as a motor whose rotation number can be controlled. For an example, the drive source 300 may include an encoder (not shown).

Although not shown, the drive source 300 may be configured as an actuator. However, when it is considered that it is difficult to control the protruding distance of the rack bar, the actuator may be more preferably configured as a motor.

Next, the door opening device 30 may include at least one power transmission gear 400 which transmits the driving force of the drive source 300 to the rack bar 200.

That is, the rack bar 200 may be rectilinearly moved by the rotational power of the drive source 300 (the motor) transmitted by the at least one power transmission gear 400 and the rack gear 203.

Particularly, the rectilinearly moving speed of the rack bar 200 may be controlled by the at least one power transmission gear 400. The moving distance of the rack bar 200 may be precisely controlled by the at least one power transmission gear 400.

As illustrated in FIGS. 13 to 15, multiple power transmission gears of the one or more power transmission gears 400 may be located on another side of the housing 100 relative to the rack bar 200. Accordingly, the avoiding end 150 formed on any one side of the housing 100 may have a sufficient size. Preferably, all of the power transmission gears 400 may be located on the another side of the housing 100 relative to the rack bar 200 such that the size of the avoiding end 150 is maximized.

The drive source 300 may be located at the same side as a side at which the power transmission gear 400 is located in opposite sides of the housing 100. Accordingly, gear coupling between the drive source 300 and the power transmission gear 400 may be achieved with a simple structure, or the avoiding end 150 formed at any one side of the housing 100 may be formed larger.

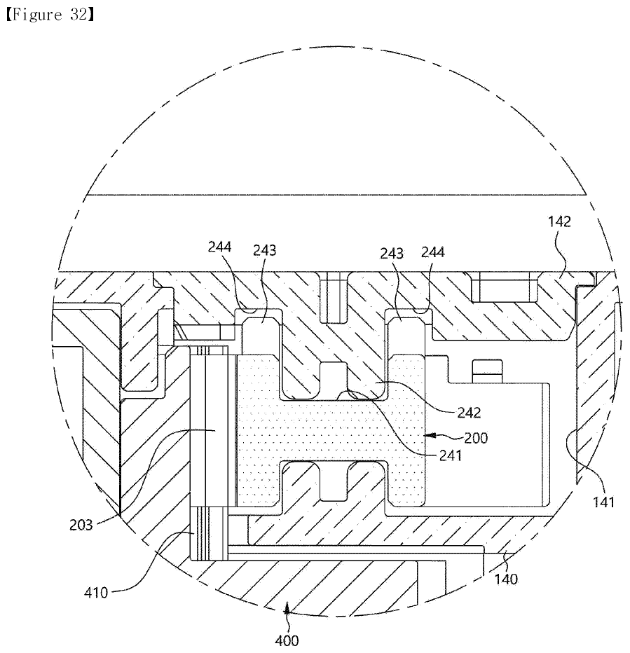

Hereinafter, the operation state of the door opening device 30 of the refrigerator according to the embodiment of the present disclosure described above will be described in more detail with reference to FIGS. 33 to 46.

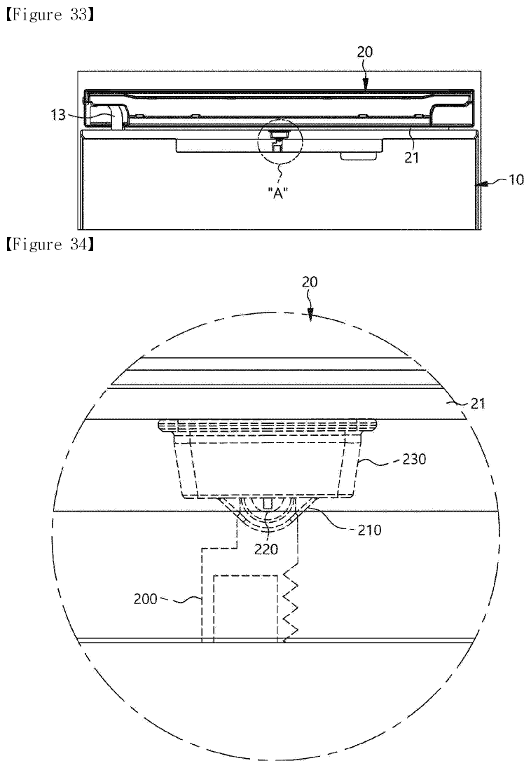

First, as illustrated in FIGS. 33 and 34, while the door 20 is closed, the rack bar 200 of the door opening device 30 may be maintained in a retracted state.

The rack bar 200 may be maintained in a state retracted up to a maximum retracting distance due to the structure of the protrusion limiting part.

For example, the limiting protrusion 242 formed on the lower surface of the rack cover 142 may be in contact with the holding groove 241 formed in the upper surface of the rack bar 200 such that excessive retraction of the rack bar 200 is prevented.

For example, when the magnet 245 installed on the rack bar 200 reaches the Hall sensor 246 provided in the housing 100, the driving of the drive source 300 may stop, so the excessive retraction of the rack bar 200 may be prevented.

When the rack bar 200 is retracted by a maximum retracting distance thereof, the head cover 230 may be maintained to be spaced apart from the surface of the door 20.

The head cover 230 may be designed to be in contact with the surface of the door 20 when the door opening device 30 is not used. However, in this case, when the rack bar 200 is not completely retracted or assembly tolerance occurs, the door 20 may be spaced apart from the cabinet 10 while the rack bar 200 is maintained in contact with the door 20.

In consideration of this, the head cover 230 of the rack bar 200 may be designed so as not to be in contact with the surface of the door 20, and thus even if the rack bar 200 is not completely retracted, the problem that the door 20 may not be completely closed may be prevented.

In an initial state in which the door opening device 30 is not used, when a signal for opening the door 20 is generated, the drive source 300 of the door opening device 30 is operated. In this case, the signal for opening the door 20 may be generated in various ways, such as a human body detection sensor provided in a refrigerator, voice recognition, remote control, home network interlocking, door handle manipulation, and a preset button contact. The drive source 300 of the door opening device 30 may be operated when a signal by at least any one of the above methods or a signal by at least two complex operations thereof is provided.

When the drive source 300 operates, the rack bar 200 may be moved forward by interlocking of each of the power transmission gears 400. In this case, the rack bar 200 may be moved forward by a preset distance.

When the rack bar 200 moves forward, the head cover 230 may come into contact with the surface of the door 20 and may push the door 20 gradually. Due to such forward movement of the rack bar 200, the rear surface (or a gasket) of the door 20 may be gradually spaced apart from the front surface of the cabinet 10.

Particularly, while the forward movement of the rack bar 200 described above is performed, the entire contact surface of the head cover 230 may be maintained to be in contact with the surface of the door 20 while the rack head 210 gradually rotates. Accordingly, the door 20 may sufficiently receive the forward moving force of the rack bar 200 even when the angle of the door 20 changes. In this case, the rack head 210 may be made of a material having rigidity and thus may be prevented from being damaged, such as tearing due to the rotation of the rack head 210. The head cover 230 which comes into contact with the door 20 may be made of a soft material, and thus during the initial contact of the head cover with the door, impact noise may be prevented or reduced. This is illustrated in FIGS. 35 to 38.

When the forward movement of the rack bar 200 is completed, the door 20 may be maintained to be spaced by a preset angle apart from the cabinet 10. For example, the preset angle may be an angle of the first rotation range in which the rack head 210 can rotate to any one side from the front end of the rack bar 200.

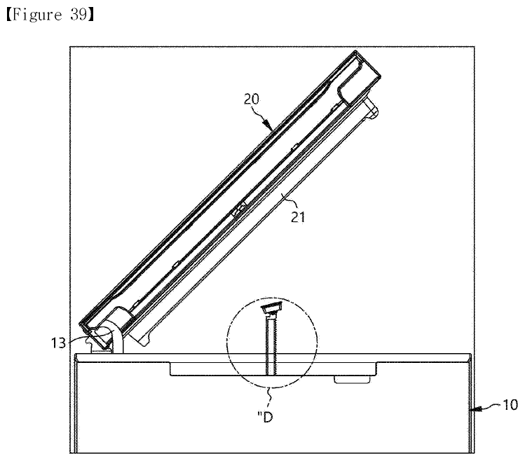

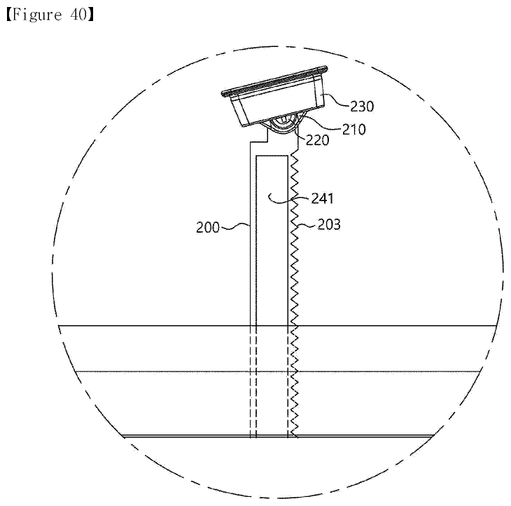

Next, a user may additionally open the door 20 manually so as to completely open the door 20. This is illustrated in FIGS. 39 and 40.

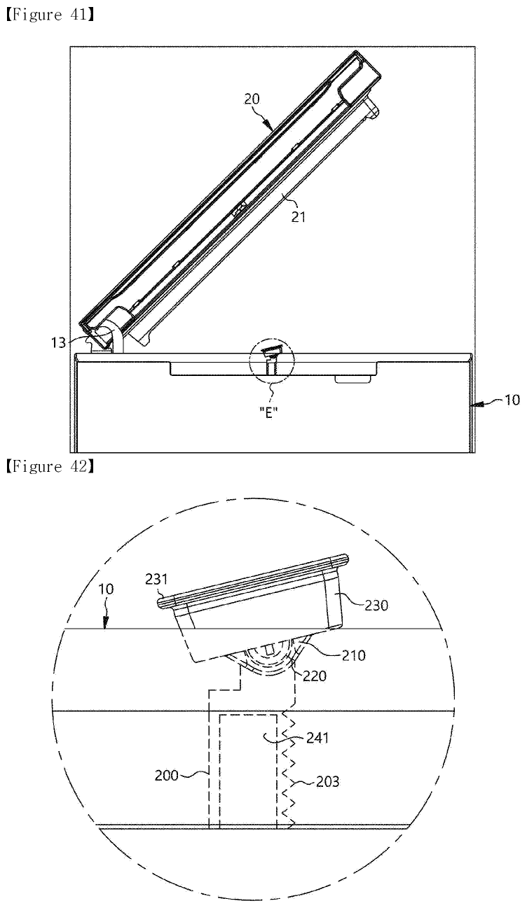

When the door 20 is spaced apart from the rack bar 200 by a user additionally opening the door 20 manually, the drive source 300 of the door opening device 30 may operate such that the rack bar 200 is retracted into the housing 100. This is illustrated in FIGS. 41 to 46.

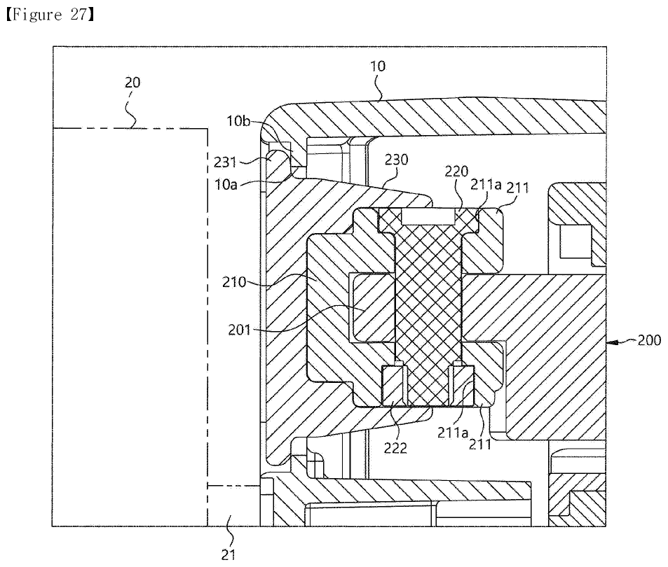

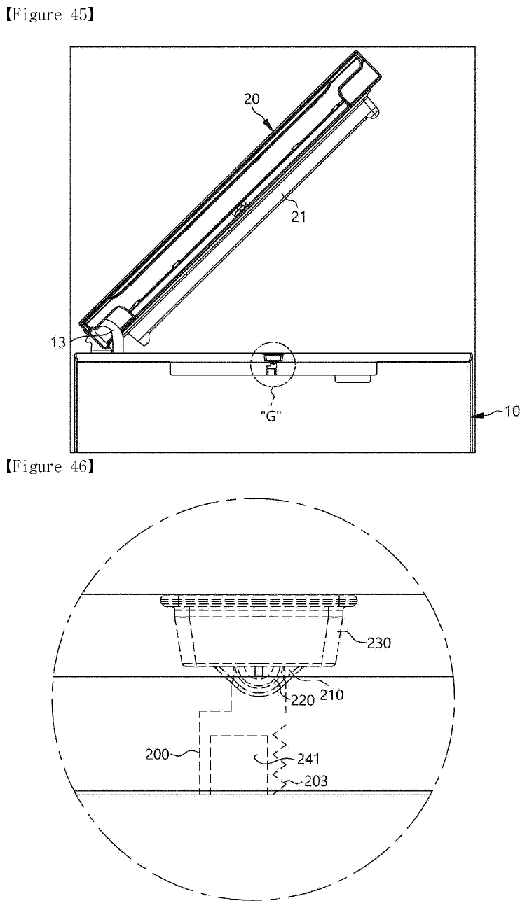

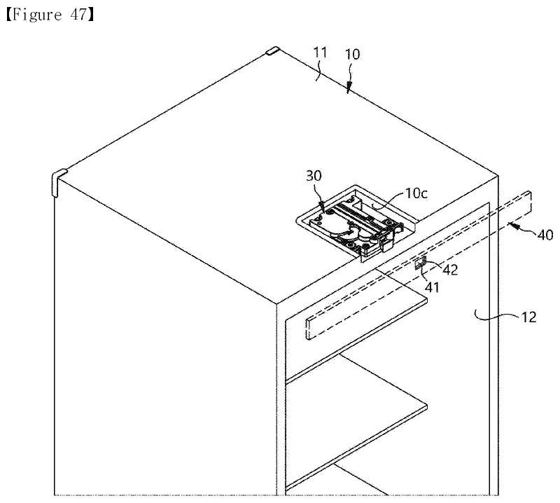

Particularly, while the rack bar 200 is being moved into the housing 100, the support rib 231 formed on the head cover 230 may hit the support jaw 10b (see FIG. 27) formed on the cabinet 10, which may rotate the rack head 210. Accordingly, the rack head 210 may be returned to an initial position thereof. This is illustrated in FIGS. 45 and 46.

The rack bar 200 may be retracted into the housing 100 and then may be maintained in a stationary state.

When the door 20 is not further opened by a user for a preset period of time, the door opening device 30 may operate to return the rack bar 200 to an initial position thereof. In this case, the door 20 may move to close the storage compartment by elastic restoring force of an elastic member (not shown) installed on the hinge 13.

That is, the rack bar 200 may be moved out such that the door 20 is rotated to such an extent that the elastic restoring force can be provided, and when the door 20 is not opened additionally, the door 20 may be returned by elastic restoring force to be closed.

Finally, the door opening device 30 of the refrigerator according to the present disclosure described above may have vertical height decreased as much as possible through the improvement of the structure of the motor seating part 131 of the housing 100 (for example, the position of the fastening hole or the provision of the avoiding jaw), thereby reducing entire thickness of the door opening device 30.

In the door opening device 30 of the refrigerator according to the present disclosure, a portion of the rear surface of the housing 100 in which the rack bar 200 is located may be configured to be open. Accordingly, the rack bar 200 may be configured to be sufficiently long, and thus may operate to be exposed by a predetermined distance regardless of the type (a front-to-rear width) of the refrigerator or the door 20.

In the door opening device 30 of the refrigerator according to the present disclosure, the head cover 230 made of a soft material and the rack head 210 installed rotatably on the rack bar 200 may be made of materials different from each other. Accordingly, noise generated when the rack bar 200 hits the door may be reduced, and the rack head 210 may be prevented from being torn due to frequent rotation of the rack head 210.

In the door opening device 30 of the refrigerator according to the present disclosure, instead of the head cover 230, the rack head 210 may be rotatably coupled to the rack bar 200, so damage to the head cover 230 due to repeated rotation of the rack head may be prevented.

In the door opening device 30 of the refrigerator according to the present disclosure, the avoiding end 150 may be formed on any one side of the housing 100, and thus the door opening device may be installed upside down regardless of the installation position of the door opening device. Accordingly, the door opening device 30 may be properly installed according to the structure or shape of an installation portion thereof, and can be used in common regardless of the model of a refrigerator.

In the door opening device 30 of the refrigerator according to the present disclosure, the fastening parts 110 and 120 of the housing 100 may be disposed respectively at positions symmetrical to each other in left and right directions relative to the center of the housing 100, so the housing 100 may be installed to be turned upside down.

The door opening device 30 of the present disclosure may be installed in various ways depending on the type of a refrigerator. This will be described for each embodiment as follows.

First, the door opening device 30 of the present disclosure may be installed on various positions of the cabinet 10 according to the size (a left-to-right width) of a door 20 or the number of doors 20.

For an example, in case of a refrigerator having one door 20, in a state in which the door 20 is closed, the door opening device 30 may be disposed closer to the center of the cabinet 10 than the hinge 13 of the door 20. For example, as illustrated in FIGS. 2 to 5, the door opening device 30 may be installed in the center portion of the cabinet when the front surface of the cabinet 10 is divided into three equal parts in a left-to-right direction.

Of course, the door opening device 30 may be installed in the center of the front surface of the cabinet 10. However, in consideration of a power line connected to the associated door opening device 30 or other components installed on the upper surface of the cabinet 10, the door opening device 30 may be installed at a position as close to the center of the front surface of the cabinet 10 as possible instead of the center thereof. In this case, regardless of the position of the hinge 13 connected to the door, the door opening device 30 may provide the opening force of the door to almost the same degree even if the door opening device 30 is installed upside down. Accordingly, it is not necessary to design a control program differently according to the opening direction of the door.

For another example, although not shown, in case of a refrigerator in which two doors 20 are provided, the door opening device 30 may include two opening devices, and each of the two opening devices may be disposed to push a portion between the center of each of the doors 20 and the end of each of the doors 20.

Next, the door opening device 30 of the present disclosure may be installed in different parts of the cabinet 10 depending on the type of a refrigerator.

For an example of the installation position of the door opening device 30, as illustrated in FIG. 47, the door opening device 30 may be installed to be received inside the cabinet 10.

In this case, a receiving groove 10c may be formed in the upper end of the front surface of the cabinet 10 by being recessed therefrom such that the door opening device 30 is received in the receiving groove.

Meanwhile, the receiving groove 10c may be preferably configured to be blocked from the outside. That is, the receiving groove 10c may not be exposed to the outside such that the door opening device 30 is also not exposed to the outside.

To this end, as illustrated in FIGS. 47 to 49, a manipulation panel 40 may be provided on the front of the receiving groove 10c in the front surface of the cabinet 10. The manipulation panel 40 may include at least one manipulation button (a touch button or a pressure button) or a manipulation wheel to manually control the operation of the refrigerator. Of course, the manipulation panel 40 may include at least two manipulation panels, and at least any one manipulation panel of the manipulation panels 40 may be disposed in front of the receiving groove 10c. Accordingly, the door opening device 30 may be prevented from being exposed to the outside of the cabinet 10.

The protruding hole 41 may be formed in the manipulation panel 40 such that the rack bar 200 of the door opening device 30 may pass through the protruding hole. Accordingly, the rack bar 200 may pass through the manipulation panel 40 and may push the door 20.

When the head cover 230 is excessively inserted from the surface of the cabinet 10 and is located inside the cabinet 10, it may be difficult to expose the head cover 230 again to the outside by passing the head cover 230 through the cabinet 10. In consideration of this, the support jaw 42 may be formed on the periphery of the protruding hole 41 by being recessed therefrom, and the support rib 231 seated in the support jaw 42 may be formed on the head cover 230 by protruding therefrom. That is, the head cover 230 may be disposed to be prevented from being inserted into the surface of the cabinet 10, and thus the head cover 230 may be prevented from passing through the manipulation panel 40 due to the excessive backward movement of the heads cover.

As described above, when the door opening device 30 is installed to be received in the receiving groove 10c, the first fastening part 110 of the housing 100 may be provided with the fastening end 112 (see FIGS. 6 to 9). The fastening end 112 may be used to fasten the front surface of the housing 100 to the front surface of the cabinet 10 when the door opening device 30 is inserted into and coupled to the cabinet 10. In this case, the fastening end 112 may be provided on the front surface of each of the first fastening parts 110. Particularly, the fastening end 112 may be configured to be removable from the first fastening part 110. That is, when coupling the door opening device 30 to the upper surface of the cabinet 10, the door opening device 30 may be fastened to the cabinet 10 by the first fastening part 110, and when inserting the door opening device 30 into the cabinet 10, the door opening device 30 may be fastened to the cabinet 10 by the fastening end 112. Accordingly, the door opening device 30 may be used in common for various types of refrigerators.

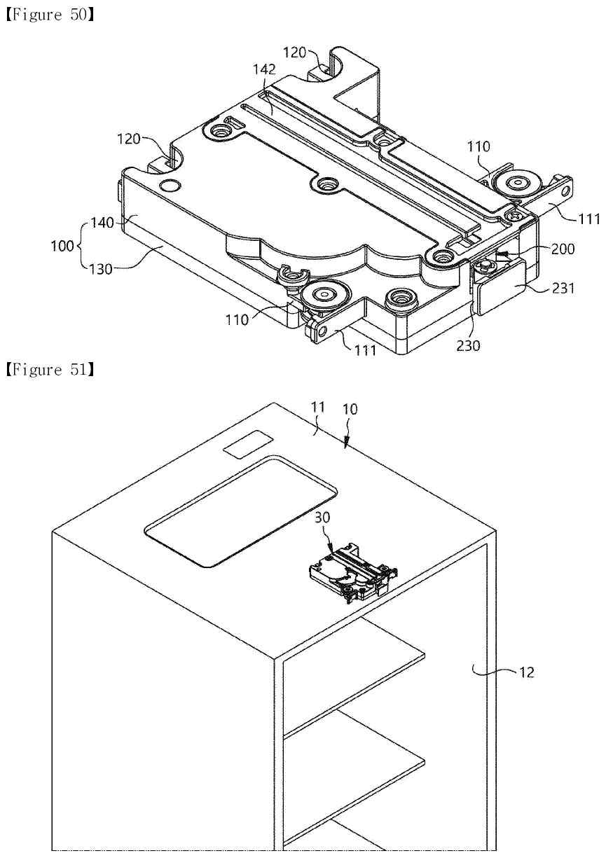

As illustrated in FIG. 50, instead of the fastening end 112, the first fastening part 110 may be configured to be removable from the housing 100. That is, the first fastening part 110 may be used as the fastening end 112. In this case, a structure (for example, the fastening hole) for fastening the first fastening part 110 to the front surface of the cabinet 10 may be provided.

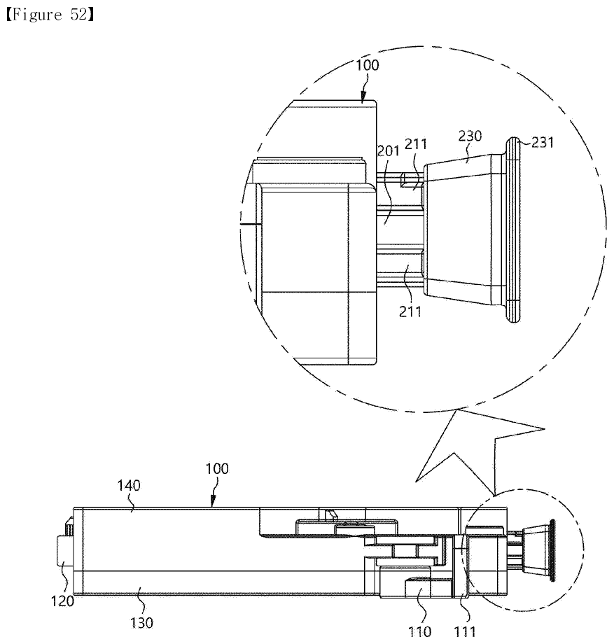

For another example of the installation position of the door opening device 30, as illustrated in FIGS. 51 and 52, the door opening device 30 may be installed on the upper surface of the cabinet 10. For example, the door opening device 30 may be provided on the upper surface of the outer casing 11.

Of course, when the door opening device 30 is installed on the upper surface of the outer casing 11, various foreign matters may be introduced into the door opening device, and beauty of the apparent design of the door opening device may deteriorate.

In consideration of this, the door opening device 30 may be installed in a hinge cover (not shown) provided on the upper surface of the outer casing 11. That is, the hinge cover may be used such that the door opening device 30 is not exposed to the outside. In this case, the hinge cover may be a cover that covers the hinge 13 of the door 20 such that the hinge 13 is protected from an external environment.

Of course, in the case of the model of a refrigerator in which the hinge cover is not provided, a separate cover (not shown) may be configured to prevent the exposure of the door opening device 30 to the outside.

For another example of the installation position of the door opening device 30, the door opening device 30 may be provided between the outer casing 11 and the inner casing 12. That is, the door opening device 30 may be installed in a gap between the outer casing 11 and the inner casing 12 such that the height increase of the refrigerator due to the door opening device 30 may be prevented.

For example, the door opening device 30 may be installed on the upper surface of the inner casing 12.

In this case, the door opening device 30 may be fastened to the upper surface of the inner casing 12 by using each of the fastening parts 110 and 120. Accordingly, even if space between the outer casing 11 and the inner casing 12 is filled with a filler (for example, a foam material), the position change of the door opening device 30 may be prevented.

In this case, the manipulation panel 40 may be disposed at the installed portion of the door opening device 30 in a front surface between the outer casing 11 and the inner casing 12. That is, the door opening device 30 may be located behind the manipulation panel 40 such that the exposure of the door opening device 30 to the outside can be minimized.

The second rib 201 formed on the rack bar 200 of the door opening device 30 may be formed at any one of a central side, upper side, or lower side of the front surface of the rack bar 200.

For an example, as illustrated in FIG. 52, in a case in which the second rib 201 is located in the center of the front surface of the rack bar 200, when the door opening device 30 is turned upside down, the position of the second rib 201 (or the position of the head cover) may be always the same. Accordingly, a portion at which the door 20 is pushed may be the same, and the second rib 201 located in the center may be usefully applied when various interfering elements are located at the installation portion of the door opening device 30.

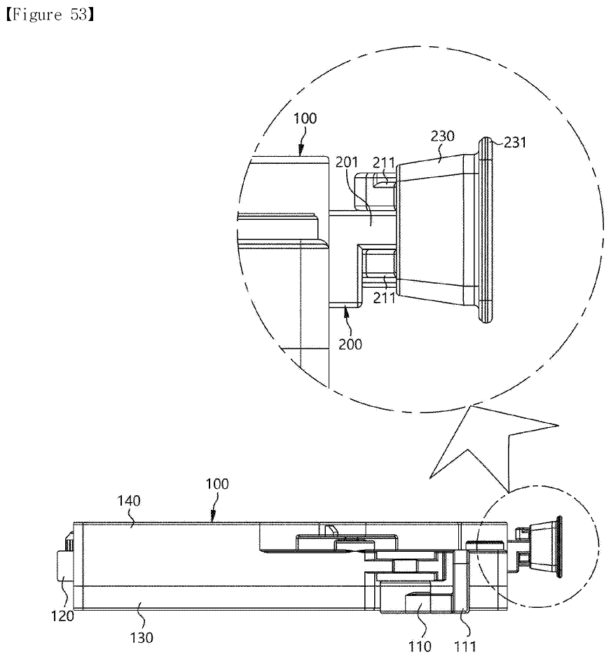

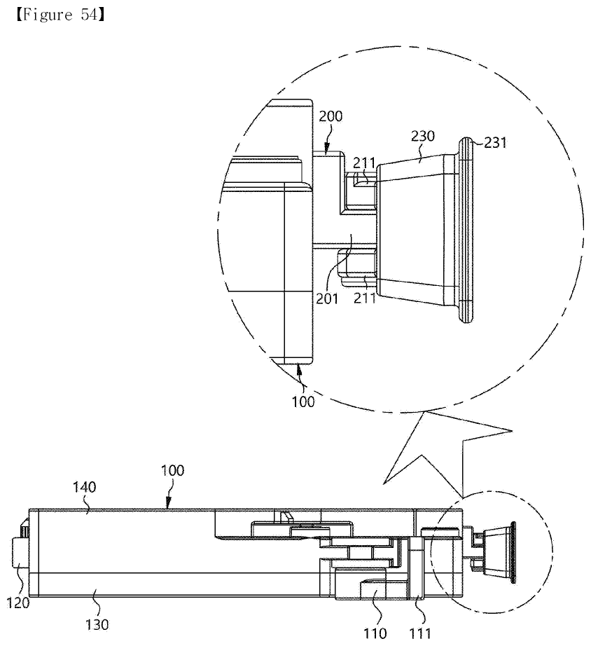

For another example, as illustrated in FIGS. 53 and 54, in a case in which the second rib 201 is located on the upper or lower side of the front surface of the rack bar 200, when the door opening device 30 is turned upside down, the position of the second rib 201 (or the position of the head cover) may be changed. Accordingly, according to a portion of the door 20 which is pushed, the door opening device 30 may be differently applied.

Accordingly, the door opening device constituting the refrigerator of the present disclosure may be embodied in various forms.

1.-30. (canceled)

31. A refrigerator comprising:
a cabinet having a storage compartment;
a door which opens and closes the storage compartment; and
a door opening device which assists in opening the door,
wherein the door is disposed rotatably on a hinge, and
the door opening device comprises:
a housing disposed at the cabinet and constitutes an exterior of the door opening device, and
a rack bar which moves forward and rearward from the housing, the rack bar configured to move forward such that a front end of the rack bar passes through a front surface of the housing to protrude toward the door.

32. The refrigerator of claim 31, wherein the housing is configured to have a front-to-rear length longer than a left-to-right width.

33. The refrigerator of claim 31, wherein the rack bar is located at a center portion of the housing and is disposed to rectilinearly move in forward and rearward directions regardless of an opening angle of the door.

34. The refrigerator of claim 31, wherein the housing comprises an avoiding end which is more recessed inward than a portion at an opposite side of the housing.

35. The refrigerator of claim 31, the door opening device is disposed closer to a center of the cabinet than the hinge of the door.

36. The refrigerator of claim 31, wherein the housing in which the rack bar is disposed comprises an open portion formed at a rear surface of the housing to allow a rear end of the rack bar to pass through the open portion.

37. The refrigerator of claim 31, wherein a rack gear is formed at one side surface of the rack bar, and
the door opening device comprises one or more power transmission gears, wherein at least one of the power transmission gears engages with the rack gear so as to transmit a driving force of a drive source to the rack bar.

38. The refrigerator of claim 37, wherein the one or more power transmission gears is located at a side opposite to the one side surface of the rack bar.

39. The refrigerator of claim 37, wherein the drive source is located at a same side as a side at which the one or more power transmission gears is located, and located at opposite sides relative to a surface of the housing.

40. The refrigerator of claim 37, wherein the housing comprises:
a lower base in which at least any one of the drive source and the one or more power transmission gears is disposed, and
an upper cover which covers an upper surface of the lower base.

41. The refrigerator of claim 40, wherein a fastening hole is formed at the lower base so as to install the drive source and is located to avoid the one or more power transmission gears.

42. The refrigerator of claim 40, wherein a guide groove is formed at the upper cover so as to support forward and rearward movements of the rack bar, and
an exposure hole is formed at one portion of an inside of the guide groove such that at least a portion of the at least one of the power transmission gears is exposed from the exposure hole so as to engage with the rack gear of the rack bar.

43. The refrigerator of claim 42, comprising a rack cover disposed to close an open upper surface of the guide groove.

44. The refrigerator of claim 31, comprising a protrusion limiting part provided at at least one portion of opposing portions between the rack bar and the housing so as to limit forward and rearward moving distance of the rack bar.

45. The refrigerator of claim 31, comprising a rack head rotatably disposed at the front end of the rack bar, and
a head cover disposed at an outer surface of the rack head, which comes into contact with the door.

46. The refrigerator of claim 45, wherein the rack head has a rigidity greater than a rigidity of the head cover.

47. 17 The refrigerator of claim 45, wherein the rack head is disposed to rotate left and right about a rotating pin vertically passing through the front end of the rack bar, and
at least a portion of upper and lower surfaces of the head cover is configured to cover the rotating pin.

48. The refrigerator of claim 47, wherein the rotating pin is disposed on a front-to-rear directional center line of the housing.

49. The refrigerator of claim 31, comprising a manipulation panel disposed at a front surface of the cabinet, and
the door opening device is disposed behind the manipulation panel.

50. The refrigerator of claim 49, wherein the manipulation panel comprises a protruding hole through which the rack bar passes,
a support jaw formed at a periphery of the protruding hole; and
the rack bar comprises a head cover and a support rib formed at the head cover to engage with the support jaw.

51. The refrigerator of claim 31, comprising a plurality of fastening parts disposed at the housing to couple the housing to the cabinet, wherein the plurality of fastening parts are disposed respectively at positions symmetrical to each other in left and right directions relative to a center of the housing.

52. The refrigerator of claim 51, wherein the plurality of fastening parts comprise a second fastening part formed at a rear surface of the housing by being recessed inward therefrom.

53. The refrigerator of claim 51, wherein the plurality of fastening parts comprise a first fastening part formed vertically through a front end of the housing.

54. The refrigerator of claim 33, wherein the first fastening part is configured to be removable from the housing.

55. The refrigerator of claim 31, wherein the cabinet comprises a receiving groove formed at a front surface of the cabinet by being recessed therefrom to receive the door opening device.

56. The refrigerator of claim 55, comprising a manipulation panel disposed at the front surface of the cabinet, and
the receiving groove disposed behind the manipulation panel, wherein, the manipulation panel comprises a protruding hole through which the rack bar of the door opening device protrudes.

57. A refrigerator comprising:
a cabinet having a storage compartment;
a manipulation panel disposed at a front surface of the cabinet;
a door which opens and closes the storage compartment; and
a door opening device having a rack bar so as to assist in opening the door,
wherein the door opening device is disposed behind the manipulation panel, and
a protruding hole is formed at the manipulation panel through which the rack bar of the door opening device protrudes.

58. The refrigerator of claim 57, wherein the cabinet comprises a receiving groove recessed at the front surface of the cabinet, and disposed at a rear side of the manipulation panel, and
the door opening device is disposed at the receiving groove.

59. The refrigerator of claim 57, wherein the cabinet comprises: an outer casing constituting an exterior thereof, and an inner casing located inside the outer casing and providing the storage compartment,
wherein the door opening device is provided between the outer casing and the inner casing, and behind the manipulation panel.

60. A refrigerator comprising:
a cabinet having a storage compartment;
a door which opens and closes the storage compartment;
a door opening device which assists in opening the door,
wherein the door opening device comprises:
a housing constituting an exterior of the door opening device and having a plurality of fastening parts, and
a rack bar which is moved forward and rearward by an operation of a drive source, the rack bar configured to move forward such that a front end of the rack bar passes through a front surface of the housing to protrude toward the door,
wherein the fastening parts of the housing are disposed respectively at positions symmetrical to each other in left and right directions relative to a center of the housing.
